(19) United States
(12) Patent Application Publication
(10) Pub. No.: US 2013/0189565 A1
(43) Pub. Date: Jul. 25, 2013

(54) Batteries Having Nanostructured Composite Cathode

(71) Applicant: Nanocomp Technologies, Inc., Concord, NH (US)

(72) Inventors: David S. Lashmore, Lebanon, NH (US); Mark W. Schauer, Dublin, NH (US)

(73) Assignee: NANOCOMP TECHNOLOGIES, INC., Concord, NH (US)

(21) Appl. No.: 13/795,515

(22) Filed: Mar. 12, 2013

Related U.S. Application Data
(63) Continuation-in-part of application No. 13/367,572, filed on Feb. 7, 2012.
Application No. 13/367,572 is a continuation-in-part of application No. 12/437,538, filed on May 7, 2009.
(60) Provisional application No. 61/051,249, filed on May 7, 2008.

(51) Int. Cl. H01M 4/36; H01M 10/04; H01M 4/04

(52) U.S. Cl. CPC H01M 4/366; H01M 4/045; H01M 10/04; H01M 4/0402
USPC 429/163; 429/211; 205/60; 205/57; 429/223; 429/231.8; 29/623.2; 427/113

(57) ABSTRACT

A battery having a negative electrode including an anode current collector having at least one sheet of carbon nanotubes and semiconductor material deposited on the sheet; a positive electrode including a cathode current collector having at least one sheet of carbon nanotubes having a nickel sulfide or tin sulfide deposited on the sheet; and a separator situated between the negative electrode and positive electrode is provided. Methods for forming a cathode having nickel sulfide or tin sulfide deposited on a carbon nanotube sheet are also provided.

### RELATED APPLICATIONS

This application is a continuation-in-part of U.S. patent application Ser. No. 13/367,572, filed Feb. 7, 2012, which is a continuation-in-part of U.S. patent application Ser. No. 12/437,538, filed May 7, 2009, which claims priority to U.S. Provisional Patent Application Ser. No. 61/051,249, filed May 7, 2008, and to U.S. Provisional Patent Application Ser. No. 61/692,572, filed Aug. 23, 2012, the content of each of which is hereby incorporated herein by reference in its entirety.

### TECHNICAL FIELD

The present invention relates to batteries, and more particularly, to secondary batteries employing sheets of non-woven carbon nanotubes.

### BACKGROUND

Carbon nanotubes are known to have extraordinary tensile strength, including high strain to failure and relatively high tensile modulus. Carbon nanotubes may also be highly resistant to fatigue, radiation damage, and heat. To this end, the addition of carbon nanotubes to composite materials can increase tensile strength and stiffness of the composite materials.

Within the last fifteen (15) years, as the properties of carbon nanotubes have been better understood, interests in carbon nanotubes have greatly increased within and outside of the research community. One key to making use of these properties is the synthesis of nanotubes in sufficient quantities for them to be broadly deployed. For example, large quantities of carbon nanotubes may be needed if they are to be used as high strength components of composites in macroscale structures (i.e., structures having dimensions greater than 1 cm.)

One common route to nanotube synthesis can be through the use of gas phase pyrolysis, such as that employed in connection with chemical vapor deposition. In this process, a nanotube may be formed from the surface of a catalytic nanoparticle. Specifically, the catalytic nanoparticle may be exposed to a gas mixture containing carbon compounds serving as feedstock for the generation of a nanotube from the surface of the catalyst particle.

Recently, one promising route to high-volume nanotube production has been to employ a chemical vapor deposition system that grows nanotubes from catalyst particles that “float” in the reaction gas. Such a system typically runs a mixture of reaction gases through a heated chamber within which the nanotubes may be generated from catalyst particles that have precipitated from the reaction gas. Numerous other variations may be possible, including ones where the catalyst particles may be pre-supplied.

In cases where large volumes of carbon nanotubes may be generated, however, the nanotubes may attach to the walls of a reaction chamber, resulting in the blockage of nanomaterials from exiting the chamber. Furthermore, these blockages may induce a pressure buildup in the reaction chamber, which can result in the modification of the overall reaction kinetics. A modification of the kinetics can lead to a reduction in the uniformity of the material produced.

An additional concern with nanomaterials may be that they need to be handled and processed without generating large quantities of airborne particulates, since the hazards associated with nanoscale materials are not yet well understood.

The processing of nanotubes or nanoscale materials for macroscale applications has steadily increased in recent years. The use of nanoscale materials in textile fibers and related materials has also been increasing. In the textile art, fibers that are of fixed length and that have been processed in a large mass may be referred to as staple fibers. Technology for handling staple fibers, such as flax, wool, and cotton has long been established. To make use of staple fibers in fabrics or other structural elements, the staple fibers may first be formed into bulk structures such as yarns, tows, or sheets, which then can be processed into the appropriate materials.

Accordingly, it would be desirable to provide a material that can take advantage of the characteristics and properties of carbon nanotubes, so that sheets made of carbon nanotubes can be processed for end use applications, such as batteries.

### SUMMARY

The present invention provides, in accordance with an embodiment, a battery comprising a negative electrode including an anode current collector having at least one sheet of carbon nanotubes with semiconductor particles, a positive electrode including a cathode current collector having at least one sheet of carbon nanotubes infiltrated with mixed metal oxides, and a separator, situated between the negative electrode and positive electrode. The battery further includes a casing made from carbon nanotube composite material. In one embodiment, the composite material can comprise carbon nanotubes and polyamide, polyphenylene sulfide, polyether ether ketone, polypropylene, bispolyamide, bismaleimide, epoxies or a combination thereof.

The carbon nanotube sheets can be made from single wall carbon nanotubes or multi-wall carbon nanotubes. The sheet of carbon nanotubes can have density of about 80 g/m². The sheet of carbon nanotubes can comprise substantially aligned carbon nanotubes and can further include lithium as an intercalation compound.

According to one embodiment, the anode includes semiconductor particles such as silicon or germanium particles. The silicon or germanium particles can be ultrasonically welded onto the carbon nanotubes. The cathode, in an embodiment, includes a sheet of carbon nanotubes infiltrated with a lithium mixed metal oxide comprising lithium, nickel, cobalt or mixtures thereof or alternatively infiltrated with zinc-nickel oxide. The separator can be a porous polyethylene membrane, or polyethylene membrane, or a combination thereof.

The present invention also provides a method for forming an anode. The method includes generating a substantially planar body defined by a matrix of carbon nanotubes in the presence of semiconductor particles so as to allow the formation of a carbon nanotube sheet with semiconductor particles throughout the matrix of nanotubes. In an embodiment, an intercalation compound, such as lithium, can be dispersed within the sheet during the formation of the sheet or infiltrated within the sheet after the formation of the sheet. A volume of the mixture can then be deposited onto a surface so as to form a substantially planar body defined by a matrix of carbon nanotubes with semiconductor particles interdispersed within the matrix of nanotubes. In some embodiments, a cloud of carbon nanotubes is formed and semiconductor particles are introduced within the cloud to form a cloud of a mixture of carbon nanotubes and semiconductor particles. In some embodiments, the lithium can be mixed with a volatile carrier in the volume and the volatile carrier is allowed to evaporate in a hot environment so as to form a carbon nanotube composite sheet. In some embodiments, the sheet is exposed to an ultrasonic pulse train in the presence of silicon or germanium particles.

The present invention also provides a method for forming a cathode. The method includes generating a substantially planar body defined by a matrix of carbon nanotubes in the presence lithium mixed metal oxide. The lithium mixed metal oxide can comprise lithium and nickel, cobalt or mixtures thereof. In one embodiment, the mixed metal oxide can be incorporated during formation of the sheet or alternatively can be sprayed onto the subsequently formed sheet. In some embodiments, a cloud of carbon nanotubes is formed and mixed metal oxide is introduced within the cloud to form a cloud of a mixture of carbon nanotubes and mixed metal oxide. A volume of the mixture can then be deposited onto a surface so as to form a substantially planar body defined by a matrix of carbon nanotubes with mixed metal within the matrix of nanotubes. In some embodiments, the lithium mixed metal oxide is mixed with a volatile carrier in the volume and the volatile carrier is allowed to evaporate in a hot environment so as to form a carbon nanotube composite sheet.

The present invention also provides a method for forming a battery. The method includes incorporating a plurality of semiconductor particles into a first a sheet of carbon nanotubes to form a negative electrode; infiltrating lithium mixed metal oxide within a second sheet of carbon nanotubes to form a positive electrode; positioning between the positive and negative electrodes a separator; and sealing the positive and negative electrodes and separator into carbon nanotube sheet impregnated with a polymer. In some embodiments, the sheet is made from aligned single wall carbon nanotubes or multi-wall carbon nanotubes.

In an embodiment, a battery including a negative electrode and a positive electrode is provided. The negative electrode includes an anode current collector having at least one sheet of carbon nanotubes and semiconductor material deposited on the sheet. The positive electrode includes a cathode current collector having at least one sheet of carbon nanotubes having a nickel sulfide or a tin sulfide deposited on the sheet. Situated between the negative electrode and positive electrode is a separator.

In accordance with an embodiment, a method for forming a cathode for use in a battery is provided. The method includes depositing nickel, such as by electrodeposition, on a carbon nanotube sheet, and converting the nickel to nickel sulfide such as by a heating process.

In an embodiment, a method for forming a cathode for use in a battery is provided. The method includes depositing tin, such as by electrodeposition, on a carbon nanotube sheet, and converting the tin to tin sulfide such as by a heating process.

In an embodiment, a method for forming an anode for use in a battery is provided. The method includes providing a substantially planar body defined by a matrix of carbon nanotubes, and spraying nickel sulfide or tin sulfide onto the matrix.

In an embodiment, a method of manufacturing a battery is provided. The method includes incorporating a plurality of semiconductor particles into a first a sheet of carbon nanotubes to form a negative electrode, and depositing nickel sulfide or tin sulfide on a second sheet of carbon nanotubes to from a positive electrode. A separator is positioned between the positive and negative electrodes. The positive and negative electrodes and separator are sealed with a casing of carbon nanotube sheet.

According to one embodiment, a cathode for use in a battery is provided. The cathode includes at least one sheet of carbon nanotubes, and nickel sulfide or tin sulfide deposited on the sheet.

### BRIEF DESCRIPTION OF DRAWINGS

FIG. 1 illustrates electrical properties of carbon nanotubes made in accordance with one embodiment of the present invention.

FIG. 2 illustrates resistivity versus temperature characteristics of carbon nanotubes made in accordance with one embodiment of the present invention.

FIG. 3 illustrates resistivity versus temperature characteristics of carbon nanotubes in (and out of) the presence of a magnetic field.

FIG. 4 illustrates a sheet of nanotubes in accordance with one embodiment of the present invention.

FIG. 5 illustrates an alternative embodiment of the present invention.

FIG. 6 illustrates a Chemical Vapor Deposition system for fabricating nanotubes, in accordance with one embodiment of the present invention.

FIG. 7 illustrates a system of the present invention for formation and harvesting of nanofibrous materials.

FIG. 8 illustrates a system of the present invention for formation and harvesting of nanofibrous materials.

FIG. 9 illustrates a system of the present invention for treating nanostructured sheets post formation.

FIG. 10 illustrates insertion loss from nanostructured sheets made in accordance with one embodiment of the present invention.

FIG. 11A illustrates a nanofibrous non-woven sheet generated from the system shown in FIGS. 1-2, and from which anode and cathode of a battery can be fabricated in accordance with one embodiment of the present invention.

FIG. 11B illustrates a cross section of a matrix of nanotubes in accordance with one embodiment of the present invention.

FIG. 12 illustrates prior art battery technology.

FIG. 13 illustrates a battery using sheets of carbon nanotubes in accordance with one embodiment.

FIG. 14 is an image of micro-silicon particle powder dispersed in the carbon nanotube (CNT) conductive sheet.

FIG. 15 is an image of nano-silicon particle “welded” to carbon nanotube matrix.

FIG. 16 is a graph showing the specific conductivity as a function of frequency.

FIG. 17 is a graph showing stress strain for carbon nanotube composites.

FIG. 18a is an image of a CNT sheet, 10 g/m² electrode coated with about 30 to 50 nm of silicon deposited on each tube using a silane CVD process.

FIG. 18b is an image at higher magnification of the CNT sheet of FIG. 18a.

FIG. 19a is a graph showing the charge capacity as a function of the discharge capacity for lithiation of silicon coated CNT electrodes.

FIG. 19b is a graph showing the reversible capacity as a function of the charge capacity for lithiation of silicon coated CNT electrodes.

FIG. 20 is a graph showing dealloying capacity and coulombic efficiency as a function of the cycle index.

FIG. 21 represents a schematic of a large CNT battery for an electric vehicle.

FIG. 22 is a graph showing the conductivity as a function of the temperature for a variety of different CNT sheet treatments.

FIG. 23 is a graph showing the resistivity of copper as a function of the temperature.

### DETAILED DESCRIPTION

The present invention provides, in an embodiment, a composite material made from nanostructured sheets designed to promote, for instance, increased conductivity. In an embodiment, the sheet may include a substantially planar body. The planar body, in one embodiment, can be defined by a matrix of nanotubes. Matrix, as defined herein, is a lattice-like or net-like structure with opening between adjacent nanotubes. As there may exist openings between adjacent nanotubes in the matrix, a protonation agent may be applied to enhance contact between nanotubes for better conduction. To the extent desired, a plurality of composite sheets may be then layered on one another to enhance thickness of the sheet.

Presently, there exist multiple processes and variations thereof for growing nanotubes, and forming yarns, sheets or cable structures made from these nanotubes. These include: (1) Chemical Vapor Deposition (CVD), a common process that can occur at near ambient or at high pressures, and at temperatures above about 400° C., (2) Arc Discharge, a high temperature process that can give rise to tubes having a high degree of perfection, and (3) Laser ablation.

The present invention, in one embodiment, employs a CVD process or similar gas phase pyrolysis procedures known in the industry to generate the appropriate nanostructures, including carbon nanotubes. Growth temperatures for a CVD process can be comparatively low ranging, for instance, from about 400° C. to about 1350° C. Carbon nanotubes (CNTs), both single wall (SWNT) or multiwall (MWNT), may be grown, in an embodiment of the present invention, by exposing nanoscaled catalyst particles in the presence of reagent carbon-containing gases (i.e., gaseous carbon source). In particular, the nanoscaled catalyst particles may be introduced into the reagent carbon-containing gases, either by addition of existing particles or by in situ synthesis of the particles from a metal-organic precursor, or even non-metallic catalysts. Although both SWNT and MWNT may be grown, in certain instances, SWNT may be selected due to their relatively higher growth rate and tendency to form rope-like structures, which may offer advantages in handling, thermal conductivity, electronic properties, and strength.

The strength of the individual carbon nanotubes generated in connection with the present invention may be about 30 GPa or more. Strength, as should be noted, is sensitive to defects. However, the elastic modulus of the carbon nanotubes fabricated in the present invention may not be sensitive to defects and can vary from about 1 to about 1.2 TPa. Moreover, the strain to failure of these nanotubes, which generally can be a structure sensitive parameter, may range from a about 10% to a maximum of about 25% in the present invention.

Furthermore, the nanotubes of the present invention can be provided with relatively small diameter. In an embodiment of the present invention, the nanotubes fabricated in the present invention can be provided with a diameter in a range of from less than 1 nm to about 10 nm. It should be appreciated that the carbon nanotubes made in accordance with one embodiment of the present invention may be extended in length (i.e., long tubes) when compared to commercially available carbon nanotubes. In an embodiment of the present invention, the nanotubes fabricated in the present invention can be provided with a length in the millimeter (mm) range.

The nanotubes of the present invention can also be used as a conducting member to carry relatively high current similar to a Litz wire or cable. However, unlike a Litz wire or cable soldered to a connector portion, the nanotube conducting member of the present invention can exhibit relatively lower impedance in comparison. In particular, it has been observed in the present invention that the shorter the current pulses, the better the nanotube-based wire cable or ribbon would perform when compared with a copper ribbon or Litz wire. One reason for the observed better performance may be that the effective frequency content of the pulse, which can be calculated from the Fourier Transform of the waveform for current pulses that are square and short, e.g., about 100 ms to less than about 1 ms, can be very high. Specifically, individual carbon nanotubes of the present invention can serve as conducting pathways, and due to their small size, when bulk structures are made from these nanotubes, the bulk structures can contain extraordinarily large number of conducting elements, for instance, on the order of 10¹⁴/cm² or greater.

Carbon nanotubes of the present invention can also demonstrate ballistic conduction as a fundamental means of conductivity. Thus, materials made from nanotubes of the present invention can represent a significant advance over copper and other metallic conducting members under AC current conditions. However, joining this type of conducting member to an external circuit requires that essentially each nanotube be electrically or thermally contacted to avoid contact resistance at the junction.

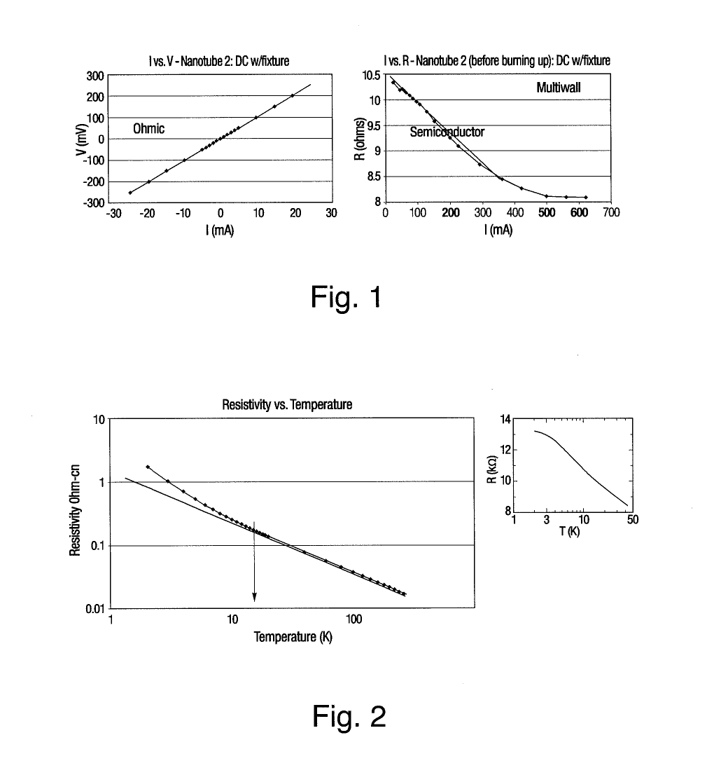

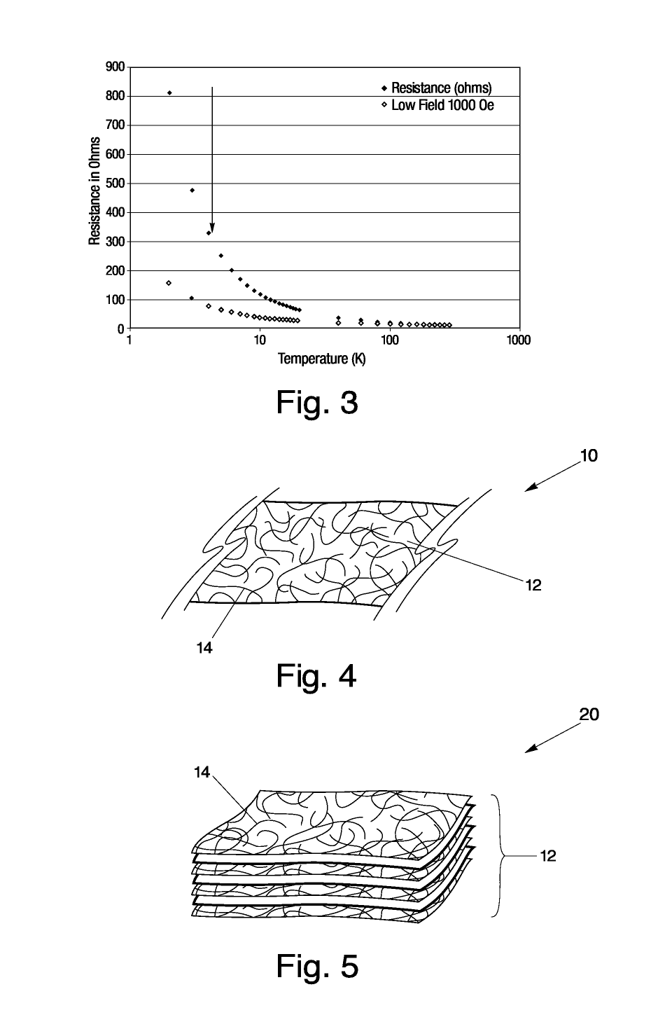

Carbon nanotubes of the present invention can exhibit certain characteristics which are shown in FIGS. 1-3. FIG. 1 illustrates the electrical properties of carbon nanotubes made in accordance with an embodiment of the present invention. FIG. 2 illustrates the resistivity of these carbon nanotubes in relation to temperature. Typical temperature dependent electrical resistance R (T) of a single MWNT measured in a four-probe configuration, i.e. the current is passed through the outer contacts and voltage is measured over the inner ones. FIG. 3 illustrates characteristics of carbon nanotube resistivity versus temperature in (and out of) the presence of a magnetic field.

It should be noted that although reference is made throughout the application to nanotubes synthesized from carbon, other compound(s), such as boron, MoS₂, or a combination thereof may be used in the synthesis of nanotubes in connection with the present invention. For instance, it should be understood that boron nanotubes may also be grown, but with different chemical precursors. In addition, it should be noted that boron may also be used to reduce resistivity in individual carbon nanotubes. Furthermore, other methods, such as plasma CVD or the like can also be used to fabricate the nanotubes of the present invention.

The present invention provides, in an embodiment, a composite material made from nanostructured composite sheets designed to increase conductivity of the carbon nanotubes within the sheet. As shown in FIG. 4, the composite material 10 may include a substantially planar body in the form of a composite sheet 12. A matrix of nanotubes 14 may define the planar body. As there may be openings between adjacent carbon nanotubes, in order to enable efficient conduction between a nanoscale environment and a traditional electrical and/or thermal circuit system, the proximity of adjacent nanotubes within the planar body may be brought closer to one another. To enhance the proximity between adjacent nanotubes, a protonation agent may be applied. In an embodiment, the composite material may be a single layer as shown in FIG. 4, or may be a plurality of layers on top of one another as shown in FIG. 5.

### System for Fabricating Sheets

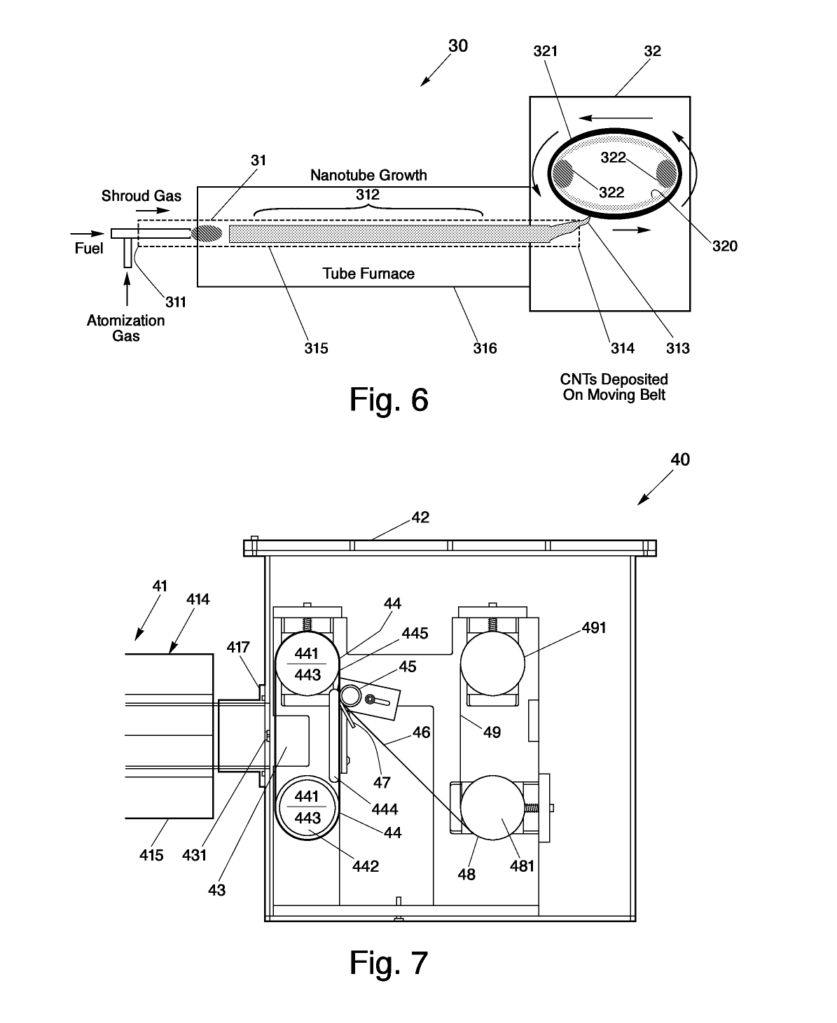

With reference now to FIG. 6, there is illustrated a system 30, similar to that disclosed in U.S. Pat. No. 7,993,620 (incorporated herein by reference), for use in the fabrication of nanotubes. System 30, in an embodiment, may be coupled to a synthesis chamber 31. The synthesis chamber 31, in general, includes an entrance end 311, into which reaction gases (i.e., gaseous carbon source) may be supplied, a hot zone 312, where synthesis of extended length nanotubes 313 may occur, and an exit end 314 from which the products of the reaction, namely the nanotubes and exhaust gases, may exit and be collected. The synthesis chamber 31, in an embodiment, may include a quartz tube 315 extending through a furnace 316. The nanotubes generated by system 30, on the other hand, may be individual single-walled nanotubes, bundles of such nanotubes, and/or intertwined single-walled nanotubes. In particular, system 30 may be used in the formation of a substantially continuous non-woven sheet generated from compacted and intermingled nanotubes and having sufficient structural integrity to be handled as a sheet.

System 30, in one embodiment of the present invention, may also include a housing 32 designed to be substantially airtight, so as to minimize the release of airborne particulates from within the synthesis chamber 31 into the environment. The housing 32 may also act to prevent oxygen from entering into the system 30 and reaching the synthesis chamber 31. In particular, the presence of oxygen within the synthesis chamber 31 can affect the integrity and compromise the production of the nanotubes 313. System 30 may also include an injector similar to those disclosed in application Ser. No. 12/140,263, incorporated herein by reference in its entirety.

System 30 may also include a moving belt 320, positioned within housing 32, designed for collecting synthesized nanotubes 313 made from a CVD process within synthesis chamber 31 of system 30. In particular, belt 320 may be used to permit nanotubes collected thereon to subsequently form a substantially continuous extensible structure 321, for instance, a non-woven sheet. Such a sheet may be generated from a matrix of compacted, substantially non-aligned, and intermingled nanotubes 313, bundles of nanotubes, or intertwined nanotubes, with sufficient structural integrity to be handled as a sheet.

To collect the fabricated nanotubes 313, belt 320 may be positioned adjacent the exit end 314 of the synthesis chamber 31 to permit the nanotubes to be deposited on to belt 320. In one embodiment, belt 320 may be positioned substantially parallel to the flow of gas from the exit end 314, as illustrated in FIG. 6. Alternatively, belt 320 may be positioned substantially perpendicular to the flow of gas from the exit end 314 and may be porous in nature to allow the flow of gas carrying the nanomaterials to pass therethrough. Belt 320 may be designed as a continuous loop, similar to a conventional conveyor belt. To that end, belt 320, in an embodiment, may be looped about opposing rotating elements 322 (e.g., rollers) and may be driven by a mechanical device, such as an electric motor. Alternatively, belt 320 may be a rigid cylinder. In one embodiment, the motor may be controlled through the use of a control system, such as a computer or microprocessor, so that tension and velocity can be optimized. The collected nanotubes may then be removed manually or by any other means off the belt 320 for subsequent use.

To the extent desired a pressure applicator, such as roller 45, may be employed. Referring to FIG. 7, the pressure application may be situated adjacent to belt 44, that may be positioned substantially perpendicular to the flow of gas, so as to apply a compacting force (i.e., pressure) onto the collected nanomaterials. In particular, as the nanomaterials get transported toward roller 45, the nanomaterials on belt 44 may be forced to move under and against roller 45, such that a pressure may be applied to the intermingled nanomaterials while the nanomaterials get compacted between belt 44 and roller 45 into a coherent substantially-bonded sheet 46. To enhance the pressure against the nanomaterials on belt 44, a plate 444 may be positioned behind belt 44 to provide a hard surface against which pressure from roller 45 can be applied. It should be noted that the use of roller 45 may not be necessary should the collected nanomaterials be ample in amount and sufficiently intermingled, such that an adequate number of contact sites exists to provide the necessary bonding strength to generate the sheet 46.

To disengage the sheet 46 of intermingled nanomaterials from belt 44 for subsequent removal from housing 42, a scalpel or blade 47 may be provided downstream of the roller 45 with its edge against surface 445 of belt 44. In this manner, as sheet 46 moves downstream past roller 45, blade 47 may act to lift the sheet 46 from surface 445 of belt 44. In an alternate embodiment, a blade does not have to be in use to remove the sheet 46. Rather, removal of the sheet 46 may be manually by hand or by other known methods in the art.

Additionally, a spool or roller 48 may be provided downstream of blade 47, so that the disengaged sheet 46 may subsequently be directed thereonto and wound about roller 48 for harvesting. As the sheet 46 is wound about roller 48, a plurality of layers may be formed. Of course, other mechanisms may be used, so long as the sheet 46 can be collected for removal from the housing 42 thereafter. Roller 48, like belt 44, may be driven, in an embodiment, by a mechanical drive, such as an electric motor 481, so that its axis of rotation may be substantially transverse to the direction of movement of the sheet 46.

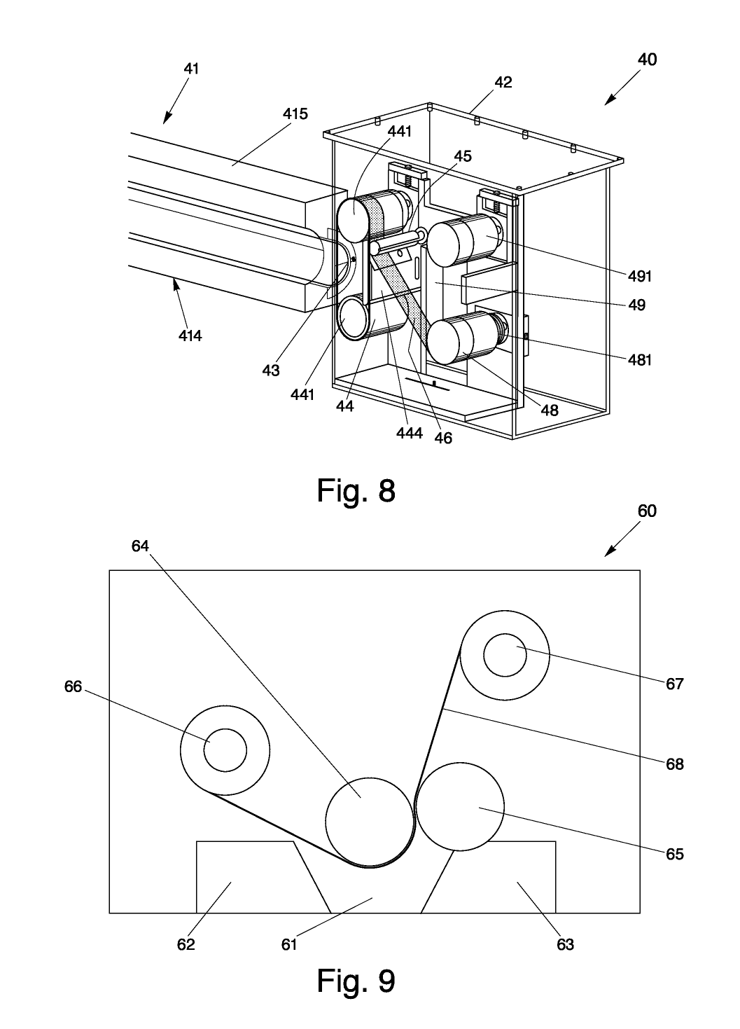

In order to minimize bonding of the sheet 46 to itself as it is being wound about roller 48, a separation material 49 (see FIG. 8) may be applied onto one side of the sheet 46 prior to the sheet 46 being wound about roller 48. The separation material 49 for use in connection with the present invention may be one of various commercially available metal sheets or polymers that can be supplied in a continuous roll 491. To that end, the separation material 49 may be pulled along with the sheet 46 onto roller 48 as sheet 46 is being wound about roller 48. It should be noted that the polymer comprising the separation material 49 may be provided in a sheet, liquid, or any other form, so long as it can be applied to one side of sheet 46. Moreover, since the intermingled nanotubes within the sheet 46 may contain catalytic nanoparticles of a ferromagnetic material, such as Fe, Co, Ni, etc., the separation material 49, in one embodiment, may be a non-magnetic material, e.g., conducting or otherwise, so as to prevent the sheet 46 from sticking strongly to the separation material 49. In an alternate embodiment, a separation material may not be necessary.

After the sheet 46 is generated, it may be left as a sheet 46 or it may be cut into smaller segments, such as strips. In an embodiment, a laser may be used to cut the sheet 46 into strips. The laser beam may, in an embodiment, be situated adjacent the housing such that the laser may be directed at the sheet 46 as it exits the housing. A computer or program may be employed to control the operation of the laser beam and also the cutting of the strip. In an alternative embodiment, any mechanical means or other means known in the art may be used to cut the sheet 46 into strips.

To the extent desired, an electrostatic field (not shown) may be employed to align the nanotubes, generated from synthesis chamber 31, approximately in a direction of belt motion. The electrostatic field may be generated, in one embodiment, by placing, for instance, two or more electrodes circumferentially about the exit end 314 of synthesis chamber 31 and applying a high voltage to the electrodes. The voltage, in an embodiment, can vary from about 10 V to about 100 kV, and preferably from about 4 kV to about 6 kV. If necessary, the electrodes may be shielded with an insulator, such as a small quartz or other suitable insulator. The presence of the electric field can cause the nanotubes moving therethrough to substantially align with the field, so as to impart an alignment of the nanotubes on moving belt.

Alternatively, the carbon nanotubes can be aligned by stretching following the synthesis of the carbon nanotube sheets as provided in co-pending U.S. application Ser. No. 12/170,092, which is incorporated herein by reference in its entirety.

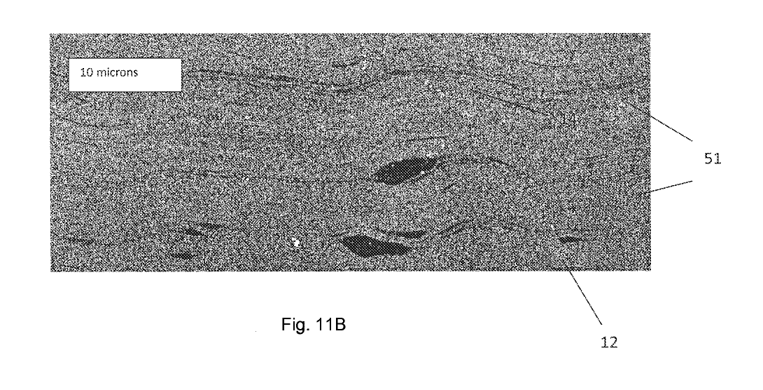

System 30, as noted, can provide bulk nanomaterials of high strength in a non-woven sheet, such as sheet illustrated in FIG. 11A. The carbon nanotubes 14, in an embodiment, can be deposited in multiple distinct layers 51 to from a multilayered structure or morphology in a single CNT sheet 12, as shown in FIG. 11B. As noted above, nanofibrous non-woven sheet 110 may be made from the deposition of multiple distinct layers of either SWNT or MWNT carbon nanotubes. In an embodiment, the tensile strength of such a non-woven sheet 110 can be over 40 MPa for SWNT. Moreover, such a sheet may used with residual catalyst from the formation of the nanotubes. However, typical residuals may be less than 2 atomic percent.

By providing the nanomaterials in a non-woven sheet, the bulk nanomaterials can be easily handled and subsequently processed for end use applications, including hydrogen storage, batteries, or capacitor components, among others.

It should be appreciated that the carbon nanotubes made in accordance with an embodiment of the present invention may not require treatment with a surfactant, and may be of at least three orders of magnitude better in electrical conductivity and thermal conductivity. Moreover, the carbon nanotube sheets made in accordance with an embodiment of the present invention may include a plurality of layers. On the other hand, the carbon nanotubes in, for instance, Bucky Paper are made of relatively short nanotubes and require treatment with a surfactant. In addition, Bucky Paper is made from only one layer of nanotubes as opposed to multilayers provided with the nonwoven sheet of the present invention.

### Treatment Process

To the extent desired, once a sheet 46 is generated, the sheet 46 may undergo treatment to enhance conductivity and/or productivity of the nanotubes in the sheet. If strips are generated, the strips may also undergo a treatment processes to enhance conductivity and productivity of the nanotubes in the strip.

Treatment of a sheet 46 after formation may, in an embodiment, include subjecting the sheet 46 to a protonation agent. One feature of the protonation agent may be to bring the carbon nanotubes in closer proximity with one another. By bringing the carbon nanotubes closer together, the protonation agent may act to reduce surface tension, reduce resistivity, and increase conductivity of the sheet. Examples of a protonation agent may include an acid such as hydronium ion, hydrochloric acid, hydrobromic acid, hydrofluoric acid, hydroiodic acid, carbonic acid, sulfuric acid, nitric acid, fluorosulfuric acid, chlorosulfonic acid, methane sulfonic acid, trifluoromethane sulfonic acid, oleum, an agent thereof, or a combination thereof, or other materials capable of being electrically and/or thermally conductive.

The protonation agent may be applied, in an embodiment, through the use of an apparatus 60, such as that shown in FIG. 9. The apparatus may, in an embodiment, include a plurality of rollers for guiding the sheet through the application process. As shown, a first roller 64 and second roller 65 may be situated adjacent one another with the second roller 65 being positioned downstream from roller 64. A tub 61 having a first end 62 and a second end 63 and containing the protonation agent may be situated underneath the first roller 64 and the second roller 65. The first roller may act to force the sheet through the tub 61 and onto the second roller 65. The second roller 65 may pull the sheet from the first roller 64 and may wring excess protonation agent fluid from the sheet. A third roller 66 may be positioned above the first end 62 of the tub near the first roller 64, while the fourth roller 67 may be positioned above the second end 63 of the tub near the second roller 65. Rollers 64, 65, 66, and 67 may be situated in series to allow the sheet 68 to move smoothly through the rollers. Of course, although shown in FIG. 9 as having four rollers, an apparatus for post treatment of sheets 68 may include a fewer number or a greater number of rollers. To the extent necessary, a hood may be situated in such a manner as to prevent fumes from the protonation agent to escape. In one embodiment, the apparatus 60 may include a hood such as a polypropylene hood.

Treating the sheet 68 with a protonation agent may involve positioning a bobbin or roll of sheet 68 on the third roller 66. The sheet 68 may then move downstream, passing from the third roller 66, through the first roller 64, into the tub 61 containing the protonation agent, and onto the second roller 65 and across the fourth roller 67.

In certain circumstances after treatment, the resulting sheet 68 may be acidic or basic. To bring the pH of the resulting sheet 68 to approximately neutral, a rinsing solution may be applied to the sheet 68. The rinsing solution may, in an embodiment, be applied continuously with the protonation agent or it may be applied independently of the protonation agent.

In another embodiment, treatment of the sheet 68 may further include spraying the sheet 68 with a second solution as it exits the furnace and is collected on the belt 320. The solution may contain, in an embodiment, a mixture of compounds that cover the outer surface of the nanotubes in such a manner as to enhance alignment of the carbon nanotubes and allow the carbon nanotubes to come into closer proximity with one another.

In an embodiment, the mixture of the second solution may include a solvent, a polymer, a metal, or a combination thereof. The solvent used in connection with the solution of the present invention can be used to lubricate the sheet in order to gain better alignment and enhancement in the properties of the carbon nanotubes. Examples of a solvent that can be used in connection with the solution include toluene, kerosene, benzene, hexanes, any alcohol including but not limited to ethanol, methanol, butanol, isopropanol, as well as tetrahydrofuran, 1-methyl-2-pyrrolidinone, dimethyl formamide, methylene chloride, acetone or any other solvent as the present invention is not intended to be limited in this manner. In an embodiment, the solvent may be used as a carrier for a polymer, monomer, inorganic salt, or metal oxide to.

Examples of a polymer that can be used in connection with the solution include a small molecule or polymer matrix (thermoset or thermoplastic) including, but not limited to, polyurethane, polyethylene, poly(styrene butadiene), polychloroprene, poly(vinyl alcohol), poly(vinyl pyrrolidone), poly(acrylonitrile-co-butadiene-co-styrene), epoxy, polyureasilazane, bismaleimide, polyamide, polyimide, polycarbonate, or any monomer including styrene, divinyl benzene, methyl acrylate, and tert-butyl acrylate. In an embodiment, the polymer may include polymer particles, that are difficult to obtain in liquid form.

Examples of a metal that can be used in connection with the solution include a salt (any transition metal, alkali metal, or alkali earth metal salt or mixture thereof including, but not limited to, nickel hydroxide, cadmium hydroxide, nickel chloride, copper chloride, calcium zincate (CaZn₂(OH)₆)), or metal oxide (any transition metal, alkali metal, or alkali earth metal oxide or mixture thereof, including but not limited to: zinc oxide, iron oxide, silver oxide, copper oxide, manganese oxide, LiCoO₂, LiNiO₂, LiNixCol-xO₂, LiMn₂O₄). In an embodiment, the metal may include polymers or volatile solvents to create a carbon nanotube metal matrix composite. Examples of such polymers or volatile solvents include powdered forms of aluminum or its alloys, nickel, superalloys, copper, silver, tin, cobalt, iron, iron alloys, or any element that can be produced in a powdered form including complex binary and ternary alloys or even superconductors.

To disperse the solution, a spraying apparatus may be used. The spraying apparatus may be any apparatus that is commercially available. In an embodiment, at one end of the spraying apparatus, there may be a spray head, through which the solution may be sprayed onto the sheet 46. In an embodiment, the spray head may be flat, round, or any other shape so long as it can permit solution to exit therethrough. To the extent desired, the spray head may emit a solution in a continuous manner or in a preprogrammed manner.

Once the sheet 68 has been treated, the treated sheet 68 may be subject to a heat source for processing of the sheet. For example, the sheet may be subject to sintering, hot isostatic pressing, hot pressing, cold isostatic pressing so as to yield a composite sheet or the desired form of the final product.

Treatment of the composite sheet may, in another embodiment, further include infusing the composite sheet with a glassy carbon material so as to increase the structural integrity of the sheet and provide substantially low resistance coupling. Glassy carbon, in general, may be a form of carbon related to carbon nanotubes and can contain a significant amount of graphene like ribbons comprising a matrix of amorphous carbon. These ribbons include sp² bonded ribbons that can be substantially similar to the sp² bonded nanotubes. As a result, they can have relatively good thermal and electrical conductivity. Examples of precursor materials from which glassy carbon can be made include furfuryl alcohol, RESOL resin (i.e., catalyzed alkyl-phenyl formaldehyde), PVA, or liquid resin or any material known to form glassy carbon when heat treated. Of course, other commercially available glassy carbon materials or precursor materials can be used.

In accordance with an embodiment of the present invention, the carbon nanotube sheet can be chemically treated to allow for substantial alignment of the carbon nanotubes within the sheet. The carbon nanotube sheet can be further treated to insert an active compound or intercalation element, such as Lithium, as described herein.

### Battery Applications

Batteries are generally a type of electrochemical cell that contain a pair of electrodes and an electrolyte disposed between the electrodes. One of the electrodes may be referred to as a cathode, wherein an active material is reduced during discharge. The other electrode may be referred to as an anode, wherein another active material is oxidized during discharge. Secondary batteries are generally referred to as batteries capable of charging electricity after discharge.

Research has been conducted on secondary batteries, such as lithium secondary batteries, because of their high voltage and high energy density. Particular attention has been paid to an electrode material for the cathode of the secondary battery. For example, U.S. Pat. No. 4,833,048 discloses a rechargeable battery obtained by combining a disulfide compound with metal M which supplies and captures the cations (M⁺). The rechargeable battery provides an improved energy density of at least 150 Wh/kg. However, the difference between the oxidation potential and the reduction potential of the disulfide compound is very large. According to the theory of electrochemical reaction, the electron transfer of the disulfide compound proceeds extremely slowly at room temperature. Therefore, it can be difficult to obtain a rechargeable battery providing a higher current output of 1 mA/cm² or more at room temperature. The operation of a battery comprising an electrode of disulfide compound is limited to high temperatures in the range of 100° C. to 200° C., where the electron transfer can proceed faster.

Lithium based chemistries offer the promise of significant energy storage; but are limited by the weight of mobile lithium that can be stored and burdened by extra weight. One metric of power generating devices is the power to weight ratio versus the energy capacity. Since traditional batteries, as well as presently available secondary batteries, are made from relatively heavy components, the amount of energy generated may not be as efficient or ideal if lighter materials can be used.

Lithium based chemistries are almost ideal for batteries as their cell potential of 3 to 4.2V provides a very high energy current source. Safety issues with lithium batteries have for the most part been addressed by using lithium intercalation into graphite based anode as a lithium reservoir instead of pure lithium metal and by adding appropriate thermal links and pressure releases. This approach coupled with the use of shuttle compounds have minimized the safety issues associated with this chemistry. Remaining issues concern the weight of the various component parts, the potential for thermal run-away and external physical damage resulting from accidents that could expose lithium to air or water.

Existing battery technologies typically use a metal current collector coated with a compound that includes anode material, the cathode material, and current enhancing additions like graphite and a binder. Anode current collectors are typically copper, while cathode current collectors are typically aluminum, and casings are typically steel. Sometimes sintered graphite plate is used as a current collectors.

The present invention, on the other hand, provides a high power and high performance battery, for example, rechargeable or secondary battery, that employs one or more sheets of carbon nanotubes for both the cathode and the anode. The present invention also provides a high power and high performance battery for use in a variety of energy and power related applications.

The battery of the present invention, in general, includes a positive electrode, a negative electrode, a separator situated between the electrodes, and a casing. In some embodiments, the battery utilizes electrodes made from carbon nanotube sheet for use as current-collectors and can also utilize carbon nanotube composite casing. In some embodiments, the electrodes utilizes aligned carbon nanotube sheets into which an active compound or intercalation element, such as Lithium, is incorporated. In accordance with one embodiment of the present invention, the battery can by a Lithium ion type battery. Alternatively, in accordance of another embodiment of the present invention, the battery can be a nickel-zinc type battery.

The use a free-standing carbon nanotube sheets as an electrode in electrochemical applications in the present application permits the electrodes to maintain bifunctionality (i.e. role as both the active material and current collector). The potential for high temperature applications is contemplated since no binder is required to fabricate these electrodes, opening up the use in battery applications in excess of 200° C. (a temperature at which most conventional binders are unstable). The free-standing electrodes also offer a lightweight, flexible geometry for thin film batteries and alternative form factors. The physical properties of free-standing CNT sheets are important considerations for any application, but with lithium ion batteries the questions surrounding strength and conductivity are paramount. Since battery manufacturing typically utilizes roll coaters or dye cutting, strength is an important consideration for CNT electrodes, since binder and metal substrate are absent. The tensile strength of typical SWCNT sheet made in accordance with an embodiment of the present invention is about 80-100 MPa, although the synthesis and processing steps can dramatically affect this property. The Young's modulus for SWCNT sheets made in accordance with an embodiment of the present invention is in the range of about 5-10 GPa, which indicates that a large force can be applied to these materials prior to plastic deformation. Another convenient property is that the CNT sheets of the present invention can be shaped into any form factor required; they can easily be cut with conventional shears.

The electrical conductivity of purified SWCNT sheets of the present invention can be about 10⁶ S/m and can approach pure metal conductivity with appropriate doping. The temperature-dependent response for free-standing electrodes of the present invention also can have attractive electrical properties, including a conductivity response that shows less than about 3% variation in conductivity over the range of about 100-400 K. The electronic transport in free-standing SWCNT electrodes made in accordance with an embodiment of the present invention can be attributed to predominant metallic conduction interrupted by tunneling barriers due to tube-tube interactions, as well as contributions from phonon scattering and variable range hopping.

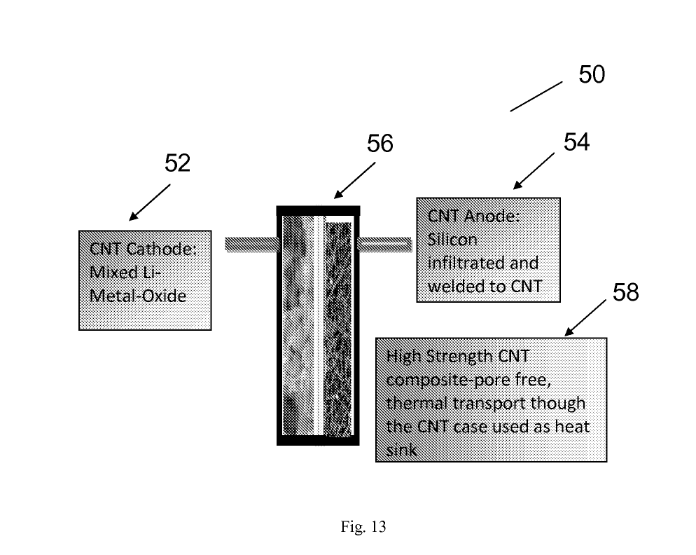

The major structural elements of the battery of the present invention include the (1) anode current collectors, (2) cathode current collectors and (3) the structural casing, all of which can be made from CNT sheets and or CNT composite sheets. FIG. 13 illustrates one embodiment of the battery. Battery 50, as shown, includes a carbon nanotube cathode 52, a carbon nanotube anode 54, a separator 56 between the cathode and the anode and a casing 58. The battery 50 can also have an electrolyte material. During charging of the battery 50, ions (for instance Lithium ions) move from the positive electrode (cathode) to the negative electrode (anode), while during discharging the ions move from the negative electrode to the positive electrode.

The carbon nanotubes composition of the present invention can also be useful in minimizing the weight of the battery as compared to existing batteries and in increasing the energy to weight and/or energy to volume ratio of the battery of the present invention.

The fabrication of stand-alone CNT electrodes can eliminate the need for metal foil substrates and increase capacity and rate capability. The free-standing CNT electrodes can store lithium and also support ultra high capacity semiconductor particles, like silicon and germanium, which may significantly increase the usable anode specific capacity (Ah/kg) in a battery.

The battery of the present invention has the advantage of not having heavy materials such as the aluminum anode and copper cathode or binders and conductive fillers. The carbon nanotube composition of the battery of the present invention can also provide for a high fracture toughness. In addition, the carbon nanotube battery of the invention can insure against thermal hot spots that have the potential for initiating run-away.

The anode and the cathode may be formed, in one embodiment, from at least one sheet of carbon nanotubes. The sheet of carbon nanotubes may be fabricated by a CVD process using system 30 shown in FIG. 6. The nanotubes generated in the gas phase using a floating catalyst CVD process can form a cloud of nanotubes that can be deposited on a rotating drum. Compounds such as nickel, zinc, nickel-zinc alloys, lithium, lithium mixed metal oxides, nickel-zinc oxides, and the like or combinations thereof, can be added to form a cloud of nanotubes with the compounds that can be deposited on a rotating drum. The drum may translate in front of the furnace exit to create a wide mat defined by a plurality of layers of carbon nanotubes within a single sheet (see FIG. 11b). Referring to FIG. 5, a plurality of layers 12 of nanotubes 14 may be deposited to build a non-woven sheet 20 to a desired density. In an embodiment, the density of the non-woven sheet is about 1 mg/cm². In some embodiments, the density of each non-woven sheet can be controlled within a wide range, for instance from about 0.1 mg/cm² to about 5 mg/cm². An example of such a non-woven sheet is shown in FIG. 11a as item 110. Each sheet, in one embodiment, can be made with varying thickness and/or numbers of layers of carbon nanotubes 14. In some embodiments, a plurality of sheets may be necessary to build a carbon nanotube mat having a density of about 80 g/m². For example, a plurality of sheets can be layered on top of one another to provide for the desired carbon nanotube density. To the extent desired, the sheet may have or may not have a protonation agent.

Cathode

The cathode, in an embodiment, may be made from, for example, from one or more sheets of aligned carbon nanotubes infiltrated with mixed metal oxides. In accordance to an embodiment, the mixed metal oxide can be a nickel-zinc oxide, a nickel-cobalt oxide, a lithium metal oxide or any other similar compound being utilized for generation of an electrical current. For example, the carbon nanotube sheet can be infiltrated with nano-scaled iron-lithium-phosphate, lithium-nickel-oxides, lithium-cobalt-nickel-oxides, lithium-cobalt-oxides, zinc-nickel oxides or combination thereof. Other substitutions may include lithium compounded with sulfur (for oxygen), sulfates, borates and silicates. Alternatively, the batteries of the present invention can be zinc air based, sodium based or lead acid based. It should be noted that although reference is made to sheets of aligned carbon nanotubes, sheets of non-aligned carbon nanotubes may also be used.

The mixed metal oxides can be incorporated within the carbon nanotube sheets during the construction of the carbon nanotube sheets for use as a cathode. In some embodiments, mixed metal oxide can be added during the nanotube growth process. For example, mixed metal oxide can be dispersed with the cloud of nanotubes during the nanotube growth process using any known methods. In an alternated embodiments, mixed metal oxide can be added or deposited after formation of the carbon nanotube sheet using known methods. For instance, mixed metal oxide can be dispersed in a volatile carrier, such as acetone, isopropanol, methanol, ethanol and the like, and spayed onto the carbon nanotube sheet. The carrier can be evaporated from the sheet by heating the sheet to form a carbon nanotube particulate composite material.

Anode

The anode of the battery of the present invention, can include one or more sheets of carbon nanotubes into which graphite particles, silicon particles, germanium particles or combination thereof are incorporated. The anode can be formed from aligned CNT sheets having a lithium intercalation compound or a zinc-nickel alloy placed into the structure either by adding lithium or zinc-nickel powder during the growth process as with the cathode or by spraying pre-formed carbon nanotube sheets. It should be noted that although reference is made to sheets of aligned carbon nanotubes, sheets of non-aligned carbon nanotubes may also be used.

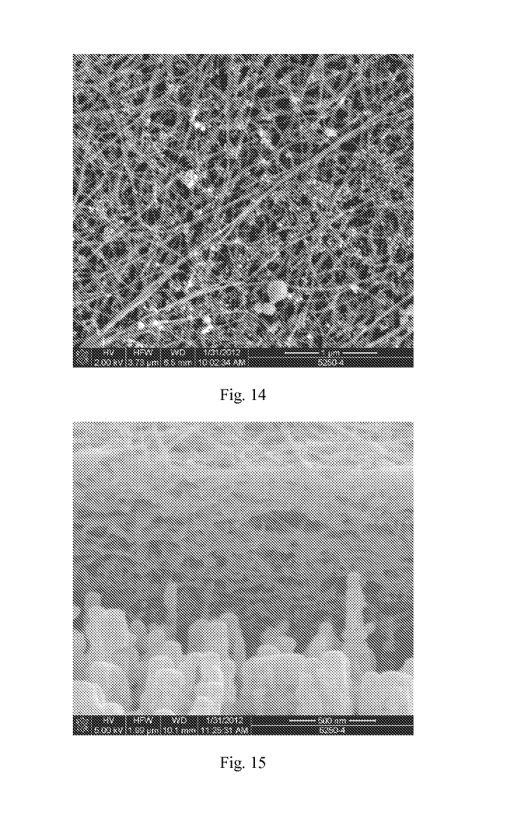

Silicon or germanium particles, in an embodiment, can be coated onto the sheets of carbon nanotube using a Chemical Vapor Deposition process. For instance, referring to FIGS. 14-15, semiconductor powder, such as silicon powder or germanium powder can be incorporated into the carbon nanotube sheets. Alternatively, semiconductor powder, such as silicon powder or germanium powder, can be welded to the carbon nanotube sheet to form the negative current collector or anode. In some embodiments, particles of silicon can be dispersed in a solvent or carrier, such as acetone, ethanol, methanol and the like, and welded to the CNT sheets by powerful ultrasonic pulse. In some embodiments, the particles of silicon or germanium are added to the carbon nanotubes using high energy welding, or similar processes known in the art, so that the silicon particles become integral with the carbon nanotubes. For instance, the particles of silicon or germanium may be positioned on top of one or more carbon nanotubes or at the surface of one or more carbon nanotubes. Alternatively, the silicon particles can be attached to the surface of the carbon nanotubes by any other suitable methods known in the art.

In some embodiments, the particles of silicon or germanium are in the micrometer or nanometer ranges. In some embodiments, the silicon or germanium particles are 100 nm or less.

By providing carbon nanotube sheets having silicon or germanium nano-particles inserted therein, it may not be necessary to add binders or conductive additives to the anode. In addition, thermal stability can be improved to the point where thermal sensors and venting valves can be potentially be eliminated.

An important impact of using an electrode made from a free standing sheet of carbon nanotubes is that the usable capacity can be increased by removing the inactive copper foil. Removal of the copper substrate has additional benefits including an increased depth of discharge and the ability to maintain a near-zero volt state of charge. It is well documented that prolonged cycling below 2.5 V leads to oxidation of the copper substrate.

In addition, it has been observed that the sheet of carbon nanotubes having silicon or germanium particles, produced by the method employed by the present invention, has an energy density up to three times higher than the energy density of commercial graphite anodes (see Table 1).

In one embodiment, 0.5 mg of nanosilicon particles were dispersed in 250 ml of acetone. Individual carbon nanotube sheets were placed into a metal holder as they are suspended in solution at a distance of 0.25 to 0.50 inches from the ultrasonic horn (Ultrasonicator VC600, Sonics & Materials, Newton). The ultrasonic horn was set to the following settings Duty Cycle: 2 and Micro-tip limit: 2.3. The duty cycle dictated the percentage of time that pulses were delivered to the samples. The amplitude, which is measured in microns, is defined as the up and down distance (excursion) that the probe tip travels. The amplitude set point was based upon the diameter of the probe and dictated the amount of energy that will be transmitted into the liquid. A timer was set to a desired value and ultrasonication was started. The ultrasonic horn was maintained in the center of the beaker to ensure that power was delivered to the samples evenly.

TABLE 1
Comparison of carbon nanotube with commercial
anode in terms of weight volumetric and fade

| | Commercial | PSI/NCTI |
|---|---|---|
| | Graphite Anode | Si/SWNT Anode |
| Energy density | 350 | 1500 |
| (mAh/g) | | |
| Energy density | 525 | 2250 |
| (mAh/cc) | | |
| Capacity Fade - | 0.2% | 2% |
| percent cycle | | |
| Current collector | 9 micron copper | SWNT |

Commercially available graphite anode with copper current collector has an energy density of 350 mAh/g while anode having silicon vapor deposited on a SWNT current collector sheet can provide an energy density of about 1500 mAh/g or more. In addition to the above, it has been determined that the sheet of carbon nanotubes of the present invention has a capacitance ten times higher or more as compared to commercially available anodes.

Separator

The positive and negative electrode can be designed, in one embodiment, to be separated by a separator. For instance, the separator can be a membrane, such as a porous and hydrophilic membrane. In some embodiments, the separator can be a polypropylene and/or polyethylene electrolytic membrane. It should be appreciated that other thin separators/membranes may alternatively be placed between the electrodes, so long as the membrane permits diffusion of the electrolyte therethrough. In an embodiment, the membrane may be a CELGARD™ porous polyethylene membrane, or polyethylene membrane, or a combination thereof, or any other membrane capable of being used with alkaline batteries.

Any suitable electrolyte solution can be used. Exemplary electrolytes include, without limitation, aqueous solutions of KOH, HNO₃, HCl, tetraethylammonium bis(oxaloato)borate (TEABOB), tetraethylammonium tetrafluoroborate (TEABF₄), or triethylmethylammonium tetraflouraborate dissolved in acetonitrile.

Casing

In some embodiments, the battery casing is made from carbon nanotube polymeric composite. The battery casing can be formed from a pre-impregnated CNT sheet. These sheets can be impregnated with a wide variety of polymeric matrices such as toughened epoxy, bismaliamide, polypropylene, polyethylene, PPS, PEEK (polyether ether ketone), PTFE and the like. In some embodiments, the sheet can include a carbon nanotube content from about 20 to about 50%. The density of the resultant composite can be less than 2 grams per cc compared with more than 7.8 g/cc for the standard steel casings.

The busses to the sheet of carbon nanotubes can either be riveted or spot welded. The latter being possible because the edges of the sheet of carbon nanotubes can, in an embodiment, be preliminarily electroplated with nickel.

These battery casings can be massed produced separately or the battery material (anode, cathode, separators, inlet values, outlet valves) can be encapsulated with the pre-impregnated during the manufacturing process. The casing can be used to thermally seal the battery anode, separator and cathode in one step. Alternatively, thermally setting matrix materials can be used to completely seal the battery following assembly. If desired safety pressure release values can be co-sealed into the structure during assembly.

Such composite material have, in some embodiments, a breaking strength higher than steel and are lighter by a factor of about 4. In addition, such carbon nanotube composite materials provide for a casing with high fracture toughness. It should be noted that casings made from carbon nanotube composites have the advantage to be much stronger and have a higher fracture toughness than conventional casings made from steel, and can be used as battery structural elements to mitigate crash damage.

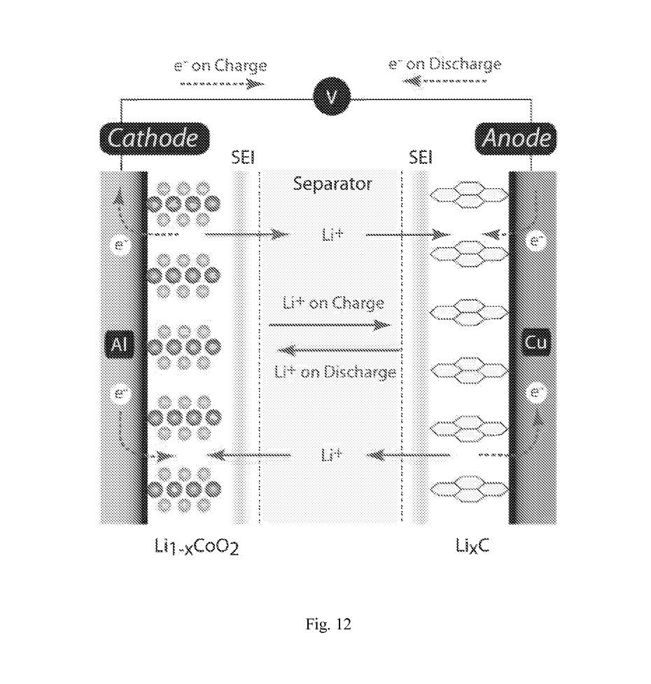

A comparison between existing technology and the battery according to one embodiment of the present invention is shown in FIGS. 12-13. In some embodiments, the anode is a mat having a plurality of carbon nanotube sheets on top of one another and comprising particles of silicon infiltrated and welded to the carbon nanotubes (FIGS. 14 and 15).

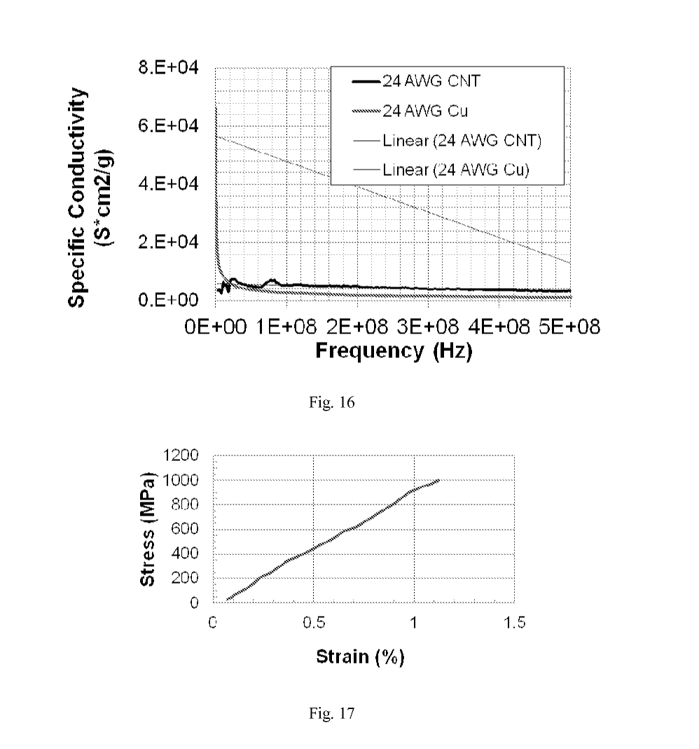

FIG. 16 illustrates the specific conductivity as function of frequency were measured for a copper collector and for a carbon nanotube collector.

FIG. 17 illustrates the stress strain curve of a 60% carbon nanotube epoxy composite. As shown, the carbon composite material has a breaking stress of 1 Gpa.

### Battery Pack

In accordance with some embodiments of the present invention, the battery may be designed to optimize the energy density and/or power. It is possible to design the battery to store a desired amount of energy by increasing the number of cells in a battery pack. Accordingly, the battery can, in an embodiment, be optimized to include two or more cells, each cell having a desired geometry and dimension. For instance, the cells can be cylindrical (spiral-wound) or prismatic. Cells can be assembled into a module or into a battery pack. Cells or modules can be packaged in casings made from carbon nanotube composites, as described herein, which have the advantage to be much stronger and have a higher fracture toughness than steel, and can mitigate crash damage.

It should be appreciated that the carbon nanotube composite material of the casing can act as a heat sink. Therefore, the design of the battery of the present invention having the components as set forth can allow the battery to operate without additional protection, such as pressure sensor, temperature sensor, pressure release valve or safety vents.

### Applications of Mixed Metal Embodiments

One of the shortcomings of the metal hydride type battery is the degradation of electrode integrity in the course of multiple charging-discharging of the battery. This is because accompanying the hydriding phase change there can also be a change in the lattice contacts that can result in an expansion leading to cracking in the alloy. Such alloy typically can withstand about 300 to 500 cycles until the battery starts to loose performance.

On the other hand, when using nanostructure materials fabricated by the method of the present invention, the number of cycles that a battery can withstand can be increased. In particular, a battery utilizing a sheet of carbon nanotubes made in accordance with an embodiment of the present invention can minimize this type of degradation, and therefore can withstand an unlimited number of charge-discharge cycles.

It should be appreciated that the sheet of carbon nanotubes have the advantage not only to be able to store as much energy as lithium ion batteries but also not degrade with charge/discharge cycle. In addition, the sheet of carbon nanotubes can offer a substantially high surface area, so that double layer charging can be accommodated, so as to hold tremendous energy that can be returned on demand if very high but short peak power is required of the battery. This behavior shows the strong distinction between the battery of the present invention and other commercially available secondary batteries.

The battery of the present invention, having the components set forth above, including sheets of conductive carbon nanotubes, has applications as a secondary battery. Secondary batteries are generally batteries that are capable of charging electricity after discharge. The design of the battery of the present invention can also permit the battery to be discharged in two steps. In particular, the first discharge of the battery can produce relatively high power, while the second discharge can produce relatively high energy.

Carbon nanotubes of the present invention possess a variety of useful properties including a high aspect ratio, channels for lithium ion intercalation, improved conductivity, both electrical and thermal, and increased capacity. It should be noted that cathodes having SWCNT or MWCNT sheets of the present invention, as well as anodes having SWCNT or MWCNT sheets of the present invention, can show an improvement in electrical and thermal conductivity and capacity. In addition, the cathodes and anodes made using the sheets of the present invention can show a reduction in weight. Moreover, the use of carbon nanotube sheets of the present invention can show an improvement in the power to weight ratios versus the energy capacity.

It should be noted that the design of the battery can be optimized to reduce battery mass and volume and to allow for use in for example, electrical vehicles. There is currently a worldwide pursuit for sustainable energy systems that will simultaneously reduce dependence on fossil fuels and greenhouse gas emissions. Underlying these initiatives are strategies towards developing more sustainable transportation (e.g. electric vehicles) and the ability to increase renewable energy consumption from solar and wind technologies. Due to the intermittency of such production and consumption requirements, these directions require significant electrical storage capabilities that are expected to be realized effectively only with advanced batteries. Lithium ion technology has emerged as the premier battery chemistry due to the increased energy density over other rechargeable technologies. However, ongoing technology demands necessitate higher energy densities which can reduce battery mass and volume characteristics in portable applications like electrical vehicles, mobile communications, and mobile grid storage. Advancements in lithium ion batteries will directly support both of ARPA-E mission areas since battery-enabled electric vehicles will significantly reduce the use of foreign energy sources and greenhouse gas emissions.

The systems and methods of the present invention can provide bulk nanomaterials of high strength, lower or similar weight, in a composite sheet. By providing the nanomaterials in a composite sheet, the bulk nanomaterials can be easily handled and subsequently processed for end use applications, including (i) structural systems, such as fabrics, armor, composite reinforcements, antennas, electrical or thermal conductors, heaters, and electrodes, (ii) mechanical structural elements, such as plates and I-beams, and (iii) cabling or ropes. Other applications can include hydrogen storage, or capacitor components.

The scale-up and commercialization of the aforementioned technology depends upon the ability to produce large quantities of materials of sufficient quality at a price which is comparable to current lithium ion battery carbons and substrates. Large sheets of high quality SWCNTS, produced in accordance with the methods of the present invention, provide a strong, lightweight and electro-thermally conductive material from which the battery can be made.

Moreover, the composite sheet may be incorporated into composite structures for additional end use applications, such as sporting goods products, helmets, antenna, morphing applications, aerospace, lightning protection flame proofing, etc. Composite sheets may further be nickel free, meaning they may be less toxic than standard products. Additionally, composite sheets may be repairable to eliminate the need to replace the composite sheets entirely or in part. In one embodiment, a composite material may be formed by impregnating the composite sheet with a matrix precursor, such as Krayton, vinyl ester, Polyphenylene Sulfide (PPS), Polyether ether ketone (PEEK), bispolyamide, BMI (bismaleimide), epoxies, or polyamides, and subsequently allowing the matrix to polymerize or thermally cure.

Composite sheets of carbon nanotubes made from the present invention can have a wide variety of applications. Examples of specific applications include electromagnetic interference shielding (EMI shielding) which may either absorb, reflect, or transmit electromagnetic waves. Shielding may be beneficial to prevent interference from surrounding equipment and may be found in stereo systems, telephones, mobile phones, televisions, medical devices, computers, and many other appliances. For these and similar applications, it may be important that the glassy carbon precursor be provided in a substantially thin layer, so that infiltration into the carbon nanotube sheet can be minimized to prevent degradation to the properties of the sheet.

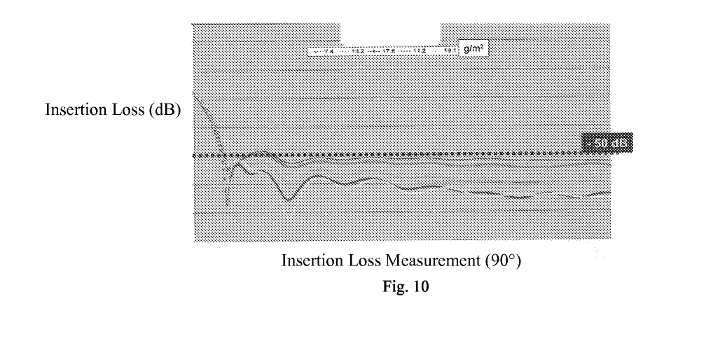

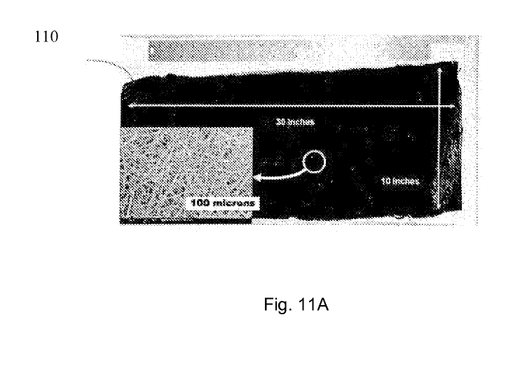

EMI shielding may further be useful in minimizing insertion loss from sheets of carbon nanotubes. Insertion loss represents the difference in power reception prior to and after the use of a composite sheet. As illustrated in FIG. 10, there is an almost immediate drop in power reception followed by a stabilization.

Composite sheets of carbon nanotubes can have additional applications, such as utilizing the resulting assembly in the absorption of radar signal (EMI shielding) or to provide other desirable properties, such as lighting protection, heat sinks, or actuators. For such applications, it may not be critical if the bonding agent penetrates the carbon nanotube sheet. Accordingly, the glassy carbon material can be coated with less care than for that carried out in capacitor, battery or fuel cell applications. In one embodiment, the substrate for applications in this example can be a graphite epoxy, e-glass epoxy, or combinations with other types of matrices.

### Additional Embodiments

In another embodiment of the present invention, there is provided a battery including (1) anode current collectors, (2) cathode current collectors and (3) the structural casing, all of which can be made from CNT sheets and or CNT composite sheets. Such battery can also include a separator between the cathode and the anode and a casing. The battery of the present invention can also have an electrolyte material. In one embodiment, the CNT cathode can have nickel sulfide or tin sulfide deposited thereon. In one embodiment, the anode can include a CNT sheet with silicon deposited thereon and the cathode can include a CNT sheet with nickel sulfide or tin sulfide deposited on the sheet.

To make such CNT cathode having a nickel sulfide deposited thereon, nickel such as Damascene nickel may be deposited on a CNT sheet and then converted to nickel sulfide such as by a heating process. In another embodiment, to make the CNT cathode having a tin sulfide deposited thereon, tin may be deposited on a CNT sheet and then converted to tin sulfide such as by a heating process.

The CNT anode may be produced by silicon coating from silane by CVD. Nickel produced by electrodeposition on the cathode is then subsequently converted to nickel sulfide (NiS). The anode including a CNT sheet having silicon deposited thereon may be formed using the methods described above.

It should be appreciated that in some embodiments, a battery may be made with conventional materials with the exception that the anode and cathode are made from CNT. For example, in some embodiments, only the cathode and anode are each made from CNT sheets, with the anode having silicon deposited on the sheet and the cathode having nickel sulfide or tin sulfide deposited on the sheet.

In some embodiments, the battery of the present invention includes CNT anode and CNT cathode current collectors without metal in the system. In some embodiments, a process to produce a battery and a battery with self-temperature regulating materials for the anode and the cathode are disclosed. In some embodiments, the battery can use CNT sheets without safety devices, such as temperature measuring systems, pressure release valves, etc. CNT sheets may be used as current collectors enabling the application of aggressive electrolytes. For example, the battery may be designed to include CNT sheet current collectors for both anode and cathode, taking advantage of the CNT conductivity and its self-temperature regulation, and allowing for the application of very aggressive high-conductivity electrolytes with no danger of passive layer breakdown as would occur on aluminum foil. In one embodiment, the anode includes a silicon coating (such as by a CVD process) on CNT sheet material and the cathode includes a NiS coating on CNT sheets. For example, the cathode may be made by first electrochemical coating Damascene nickel on CNT sheets material followed by a sulfide conversion. It should however be appreciated that other traditional cathode materials may be used on CNT current collectors.

### CNT Battery Electrode Synthesis and Characterization

CNT current collectors of the present invention may be synthesized as described herein. In one embodiment, the electrical conductivity exceeds 0.5×10⁶ S/m. Such electrodes may be fabricated 10 to 15 grams per square meter from CNT “doped” sheets. Characterization may be by four point resistivity and Van der Pauw measurements or alternatively by measuring the sheet resistance using an eddy current technique such as the Delcom (50 MHz) system. Examples of typical properties for CNT sheets are shown in Table 2.

TABLE 2
Some Properties of CNT sheets

| Property | CNT Sheet (15 g/m²) |
|---|---|
| Density (g/cm³) | 0.4-0.8 |
| Resistivity (Ω*cm) - | |
| DC | 1 × 10⁻³ |
| 1 MHz | 0.5 × 10⁻⁴ |
| Specific Conductivity | |
| (S*cm²/g) - | |
| DC | 0.17 × 10⁴ |
| 1 MHz | 1.7 × 10⁴ |
| | important for pulse charge |
| | and discharge |

| | | |
|---|---|---|
| Strength - | | With Epoxy |
| Tensile (MPa) | 200 to 500 | 2000 |
| Modulus (GPa) | 20 to 60 | 170 |
| Strain to Failure (%) | 20 | 3 |

| | |
|---|---|
| Sheet Resistance (Ω/□) | 1.0 - Raw |
| | 0.2 - “Doped” |
| Thermal Conductivity | Tunable: 10-100 |
| (W/m*K) | |
| Coefficient of Thermal | −3 × 10⁻⁶ |
| Expansion (K⁻¹) | |
| Temperature Coefficient | 1.2 × 10⁻³ - Raw |
| of Resistivity | 1.6 × 10⁻³ - Treated |

In an embodiment, CNT sheet material may be produced by a CVD process where a cloud of CNT material is deposited on a rotating belt or drum using the system described herein. In this process, material may be taken from the belt or drum and seamed into a long roll, for example, a 400 feet long roll, and treated to produce a sheet having high electrical conductivity. According to one embodiment, an 8 foot by 15 inch sheet, 10 g/m², CNT sheet may be synthesized. A CNT sheet of any other suitable dimensions may be made by this process.

The Anode: Coating CNT Sheet Material with Silicon

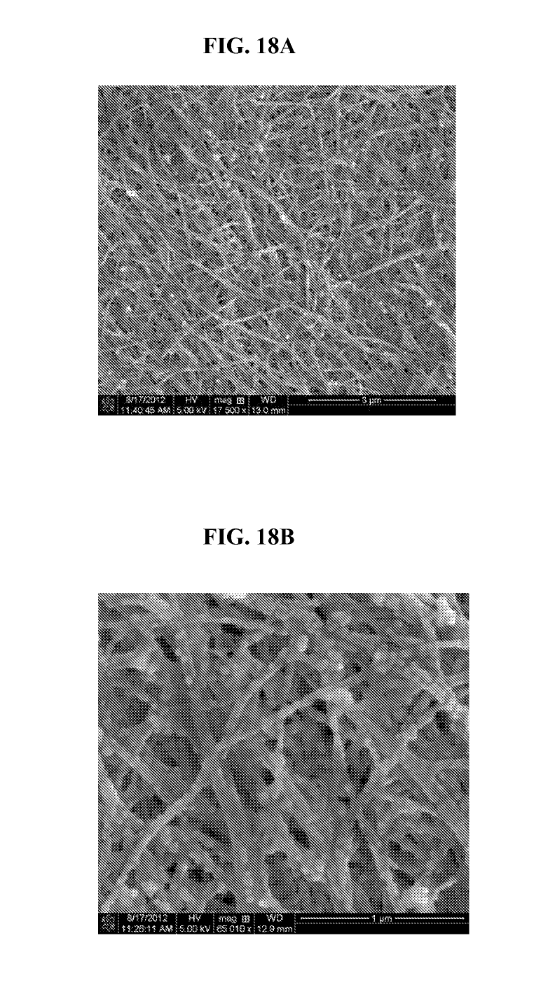

In an embodiment, the anode may be formed by coating a CNT sheet material with silicon. For example, CNT can be coated with silicon using a CVD process using Silane (SiH4). An example of a silicon coated CNT electrode is shown in FIGS. 18a and 18b. FIG. 18a is an image of a CNT sheet, 10 g/m² electrode coated with about 30 to 50 nm of silicon deposited on each tube using a silane CVD process. FIG. 18b is an image at higher magnification of the CNT sheet of FIG. 18a showing that very high surface area of the CNT sheets is magnified by the nodular growth (5 Kev, SEM).

In some embodiments, a process used to coat the CNT material is a thermally activated silane process:

SiH4 (g)→SiH4 (ab)

SiH4 (ab)→SiH2 (ab)+H2 (ab)

SiH2 (ab)+H2 (ab)→Si+H2 (ab)

H2 (ab)→H2 (g)

### Testing

In an embodiment, capacity can be been measured for several cycles. In an exemplary embodiment, capacity of the electrode is measured, for example, at loadings of 1000 mA-hrs/gram (ref) and one cycle at 1750 mA-hr/g. When the loading was reduced to 500 mA-hrs/gram, the electrode was cycled over 30 times without fade. In an embodiment, the higher loaded specimen can also be cycled without fade as long as the coating remains thin.

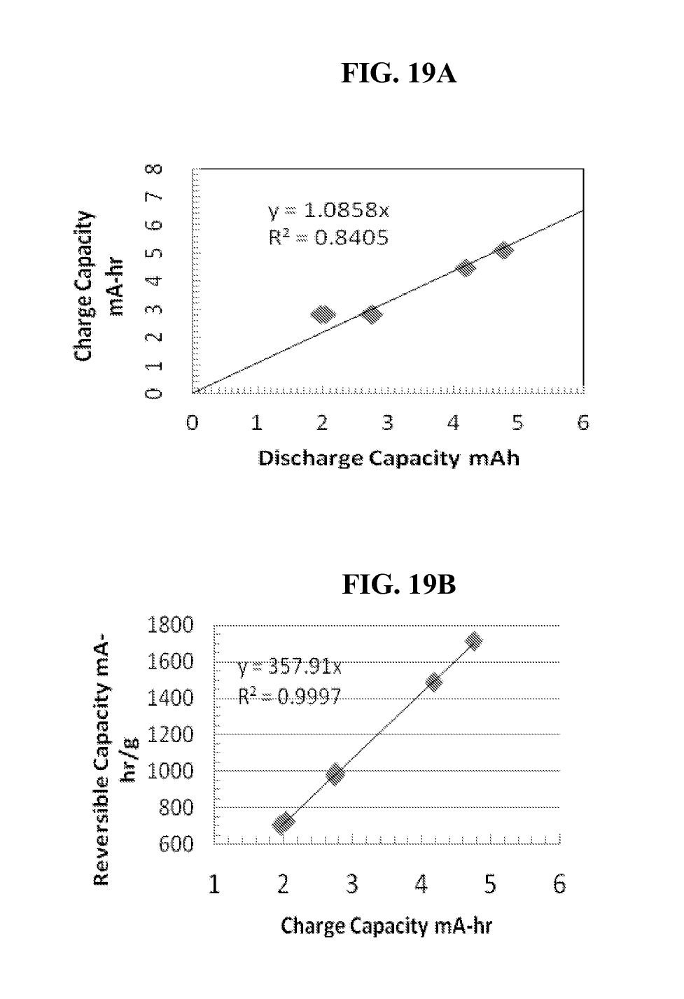

Some of the charge storage data is shown in FIG. 19a where the charge data is plotted against discharge data, and in FIG. 19b where the specific charge is illustrated. In particular, FIG. 19a is a graph showing the charge capacity as a function of the discharge capacity for lithiation of silicon coated CNT electrodes. FIG. 19b, on the other hand, is a graph showing the reversible capacity as a function of the charge capacity for lithiation of silicon coated CNT electrodes.

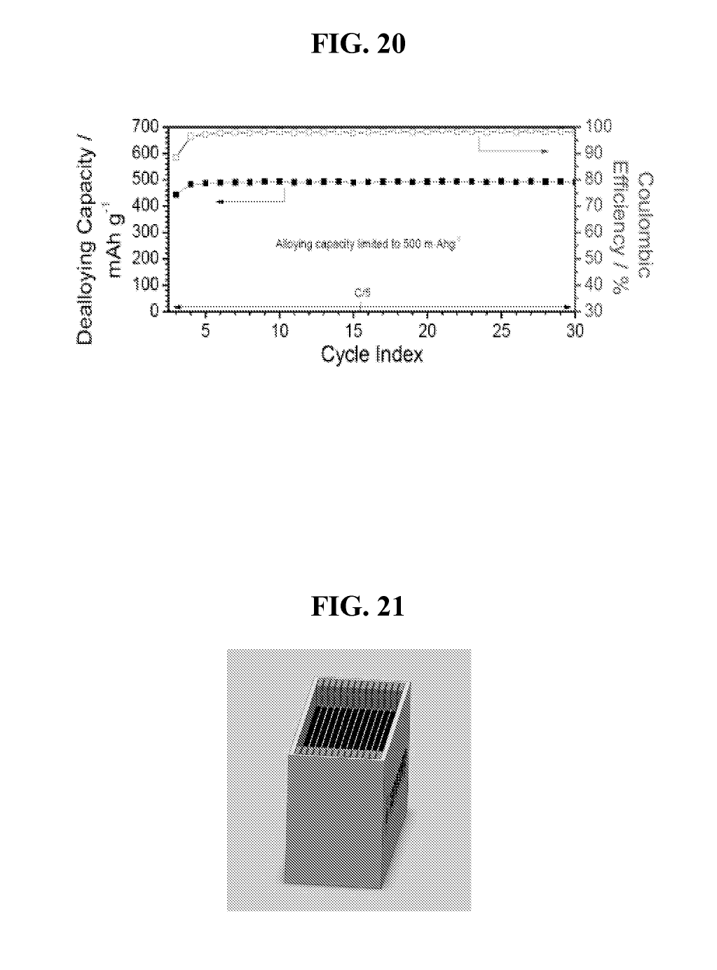

Note that up to 1700 mA-hr/g has been measured on CNT material by PSI. Cycling (full charge to discharge) data on Si coated CNT sheets have been obtained up to 500 Cycles but in this case the full charge has been limited to 500 mA-hr/g. This data is shown in FIG. 20. In particular, FIG. 20 is a graph showing dealloying capacity and coulombic efficiency as a function of the cycle index. In this latter case, no degradation of the material was observed for the few cycles that were examined.

### The Cathode: Damascene Nickel Transformed to NiS

The cathode, in an embodiment, may be made from, for example, one or more sheets of aligned carbon nanotubes infiltrated with nickel sulfide or tin sulfide or any other similar compound being utilized for generation of an electrical current. For example, the carbon nanotube sheet can be infiltrated with nano-scaled nickel sulfide or tin sulfide or a combination thereof. Alternatively, the batteries of the present invention can be zinc air based, sodium based or lead acid based. It should be noted that although reference is made to sheets of aligned carbon nanotubes, sheets of non-aligned carbon nanotubes may also be used.

The nickel sulfide or tin sulfide can be incorporated within the carbon nanotube sheets during the construction of the carbon nanotube sheets for use as a cathode. In some embodiments, nickel sulfide or tin sulfide can be added during the nanotube growth process. For example, nickel sulfide can be dispersed with the cloud of nanotubes during the nanotube growth process using any known methods. In alternate embodiments, nickel sulfide or tin sulfide can be added or deposited after formation of the carbon nanotube sheet using known methods. For instance, nickel sulfide can be dispersed in a volatile carrier, such as acetone, isopropanol, methanol, ethanol and the like, and sprayed onto the carbon nanotube sheet. The carrier can be evaporated from the sheet by heating the sheet to form a carbon nanotube particulate composite material.

In one embodiment of the present invention, it may be desirable to match the surface area and the loading of the anode and cathode. In most lithium ion batteries, the cathode material ability to store charge limits performance. This problem may be overcome by the present invention by: (1) the use of sulfur and compounds containing sulfur and (2) coating sulfur electrodes with a protective coating to prevent desorption.

There is a strong tendency for sulfur to degrade though a set of reactions called the polysulfide decomposition chain. To minimize degradation, the process of the present invention stabilizes the sulfur by encapsulating it in a sheath or organic molecules, or bonding it to another material. As such, the present invention utilizes the compound nickel sulfur which is able to hold about 800 mA-hr/g of charge making its capacity comparable to that of the silicon anode material. Loading of the electrode with nickel is followed by the conversion to the nickel-sulfur compound. Nickel can be deposited at extraordinary rates using the damascene nickel process. Once deposited, nickel can be transformed chemically to the desired NiS crystal, for example, by exposing the material to H₂S in a heated environment. Alternatively, the conversion of damascene nickel to NiS crystal can be accomplished by such methods as those disclosed in Zhang et al. Mater. Sci. Eng. (1999), Zhou et al. Adv. Funct. Mater. (2010), Huang et al. Chem. Geol. (2010), Wang et al. J. Solid State Chem. Vol. 183 (2010), p. 223, Salavati-Niasari, et al. Mater. Res. Bull. Vol. 44 (2009), p. 2246, Khiew, et al. Mater. Lett. Vol. 58 (2004), p. 762, Denholme, et al. Isr. J. Chem. (2010), which are incorporated herein by reference in their entireties.

In one embodiment, the present process includes coating the CNT tubes using electrochemically deposited Damascene nickel and loading the CNT area to match total charge potential of the anode material. Since nickel is much higher in density (8.908 g/cc) than silicon (2.3209 g/cc), problems balancing charges can be minimized Sulfides may be prepared through stoichiometric amounts of the metal and sulfur heated in evacuated and sealed quartz ampoules at 500-1000° C. or by various solution methods.

With the process described herein, (1) the CNT sheet electrodes theoretically and experimentally exhibit lower electrode resistance than comparable copper or aluminum foils and with less Joule (I²R) heating, (2) the CNT sheets tend to exhibit temperature self-regulation, so that if there is incipient thermal excursion, then the material will increase its thermal conductivity and so suppress runaway, (3) the material does not degrade, even under very aggressive electrolytes, enabling more conductive electrolytes (such as those containing lithium trifluoromethanesulfonylimide—LiTfIm) to be used, and (4) the storage capacity of this system can exceed 1100 mA-hr/g compared with about 180 to 250 mA-hr/g, for the best commercial batteries. The nickel sulfide based anode and cathode may each have a value of 1100 mA-hr/g. A matched system (anode and cathode) provides more thermal stability than the current battery and makes design simpler.

Although nickel sulfide is disclosed, it should be appreciated that tin sulfide (SnS) may also be used in connection with the cathode of the present invention. Other methods may also be used for the conversion of Damascene tin to tin sulfide including those described in Journal of Power Sources, Volumes 97-98, July 2001, Pages 198-200, Materials Science and Engineering: B, Volume 128, Issues 1-3, 15 Mar. 2006, Pages 75-79, Journal of Power Sources, Volume 146, Issues 1-2, 26 Aug. 2005, Pages 71-78, and Current Opinion in Solid State and Materials Science, Volume 4, Issue 2, April 1999, Pages 113-121, incorporated herein by reference in their entireties.

### The Electrolyte

Any suitable electrolyte solution can be used. Exemplary electrolytes include, without limitation, aqueous solutions of KOH, HNO₃, HCl, tetraethylammonium bis(oxaloato)borate (TEABOB), tetraethylammonium tetrafluoroborate (TEABF₄), or triethylmethylammonium tetraflouraborate dissolved in acetonitrile.

In an embodiment, very aggressive high conductivity electrolytes such as lithium trifluoromethanesulfonylimide in an ethylene carbonate and dimethoxy ethane solvent (Lithium Triflate Imide=LiTfIm) may be used. The use of such electrolytes may result in a battery capable of very high specific power levels.

In an embodiment, propylene carbonate and dimethoxy ethane with LiPF₆ conductive salts may be utilized. In an embodiment, trifluoromethanesulfonylimide with propylene carbonate and dimethoxy ethane may be used.

### Fabrication of Pouch Cells

In an embodiment of the present invention, pouch cells may be used for the characterization of this material. Problems with alternative coin cells include current distribution, high edge to volume ratio, metals potentially in contact with the electrolyte, etc. These issues are absent in pouch cells.

Pouch cells may be fabricated in an oxygen free glove box. The cells may be made using a commercial vacuum laminator placed in a dry box, such as a Braun dry box. In an embodiment, a Si coated CNT anode and/or a NiS coated CNT cathode may be used.

### Testing

In an embodiment, the battery of the present invention may be charged to a pre-determined load and cycle 500 times. Battery testing may be conducted with a lab view driven potentiostat with coupled coulometer.

In an embodiment, the battery may be charged to 500 mA-hr/g, to 1000 mA-hr/g loading.

Fade, specific energy based on mass and volume, and specific power based on mass and volume may be measured. Also, energy and volume efficiencies and costs per watt and costs per joule may also be measured.

### Design and Simulation of a Battery (3 Amp-Hours at 14 Volts)

In an embodiment, a battery may have 4 cells which may be interconnected flexible pouch cells. FIG. 21 showns an example of a large battery for an EV.

The characteristics of an example of a 3 A-hr battery, 3.5 V characteristics are given below in Table 3.

TABLE 3
Battery Characteristics

| | | Value | |
|---|---|---|---|
| | | Quallionⁱ | |
| Property | Value all CNT | QL0032A | Comments |
| Size | About 20 cm by | 50 by 120 by | As configured, the |
| | 20 cm by 3 mm | 7 mm | CNT battery is |
| | 3 amp-hours | 3.5 amp-hours | flexible and can |
| | 3.5 V/cell × | 3.7 V one cell | conform to packaging. |
| | 4 cells | 9 amps | The Quallion is |
| | 350 Wh/kg | max draw | shown by comparison |
| | Power: ND | 120 Wh/kg | as it has about the |
| | Packing | Power: | same charge storage. |
| | geometries | 2000 W/kg | The Quallion uses a |
| | can be | | spinel cathode and a |
| | changed as | | graphite anode both |
| | long as | | filmed on metallic |
| | surface area | | current collectors. |
| | retained. | | Both batteries are |
| | | | pouch cells. |
| Weight | 2.8 g/Si, | Not given | PC = pouch cell, |
| media | 3.5 g/Ni, | | not including |
| | 2 g/S, 50 PC | | feed-through. |
| Weight | 150 grams | 97 grams | Packaging involves |
| Total | (see note) | | 4 pouch cells; by |
| | | | combining in one |
| | | | cell, weight for |
| | | | the entire battery |
| | | | could be dramatically |
| | | | reduced. |
| Voltage | 14 V | 3.7 | |
| Capacity | 3 amp-hours | 12,600 | 1800 to 3600 C/g |
| | (10,800 | coulombs | |
| | coulombs) | | |

ⁱhttp://www.quallion.com/sub-sp-ql0032a.asp

### Testing of Large Battery

In an embodiment of the present invention, a battery may be made of a series of pouch cells joined in series. This battery is a test system, so all cells will be accessible for monitoring. Current density on this kind of battery is related to the: (1) conductivity of the electrolyte, (2) electrode spacing and (3) diffusion rates of the battery separator. For this kind of battery a highly porous separator may be used.

Alternative configurations may include electrodes at each end of the pouch.

### Applications of Nickel Sulfide and Tin Sulfide Embodiments

The batteries described above with reference to FIGS. 18a-21, have many advantages and applications. Carbon nanotube (CNT) sheet current collectors of the present invention may be used in place of conventional copper foils for the anode and aluminum foil for the cathode. This may increase energy density while reducing the chance of thermal runaway. Non-metallic CNT sheets comprised of millimeter length CNTs, for example, provide enhanced surface area and properties that manage thermal energy better than metals. For the first time, dissimilar metal current collectors such as copper and aluminum need not be used, saving weight, eliminating corrosion couples, and enabling the use of more aggressive and superior conductive electrolytes. Coating the CNT current anode collectors of the present invention with silicon results in a high capacity electrode with a comparative reduction of electrode resistance (compared with the coated copper foil); therefore, the Joule heating associated with high current performance is diminished.

The cathode electrodes of the present invention may be the same CNT sheets but coated with a nickel-sulfur. The inverse thermal conductivity relationship present in CNT materials provides a thermal stabilizing effect on the battery system, e.g., the hotter the system, the more heat is conducted away. This characteristic not only improves safety but also reduces costs due to simpler design, i.e., reduction or elimination of thermal management systems in the battery. The flexibility of CNT based current collector of the present invention enables more efficient packaging and even flexible conformable batteries to be produced. Carbon nanotube anode and cathode based current collectors for lithium based secondary batteries may also be made.

Unlike metal-collector based batteries, such thin CNT sheet-based systems enable very thin flexible and conformal batteries that reduce both fatigue and bending stresses, and allow more efficient and innovative packaging. A lower cost battery may be produced given that thermal monitoring elements such as the integrated circuit, safety release value, and temperature sensor potentially can be eliminated. Both space based batteries and more advanced batteries using sulfur based chemistries may also be produced using the processes and materials described herein. Conformal batteries are another spin out which has value for defense applications.

Applications of batteries of the present invention include, but are not limited to, satellites, ground stations, timers, and remote sensing devices. All of these systems are defined by their (1) weight, (2) reliability, (3) safety and (4) total energy content (how long they will operate). Existing lithium ion batteries are versions of commercial batteries and have proven to last a minimum of 10 years. Power (the rate of delivering energy) seems to be less important and lifetime and reliability more important. Existing technologies have adequate power. The batteries described herein improve the energy content, safety and reliability, as well as reduce weight. In an embodiment, the battery makes use of a current collector which may reduce the battery weight and enable more flexible packing, while at the same time permit a factor of 5 times more energy content. The electrode resistivity is less than that of existing commercial batteries enabling higher power and less Joule heating.

The current collectors of the present invention are made from sheets manufactured by the method of the present invention that can be substantially fatigue resistant. When using this approach, Joule heating is a factor of 4 times less that the current technology. Under high currents, this large factor is expected to be significant and translates into a light system without the need for external cooling. Energy storage is expected to increase by a factor of 5 so that smaller batteries are possible.

Table 4 shows a comparison of the proposed effort to the state-of-the-art.

TABLE 4
Comparison of CNT Battery Parameters with Current Technology.

| | Theoretical | Proven | | |
|---|---|---|---|---|
| | Capacity | Capacity | Cycle | |
| | mAh/g | mAh/g | Life | Comments |
| Li/Graphite | 372 | ~250 | Good | Existing |
| Anode | | | | technology |
| Li/Si Anode | 4212 | 2500 | Poor | Anode expansion |
| (usually | | | | during |
| particles | | | | lithiation |
| of Si) | | | | causes cracking |
| | | | | of the SI |
| Li/Si/CNT | ~3800 | 1025 | Very | Expansion |
| Anode | | proven | Good | cracking |
| | | | | avoided by thin |
| | | | | Si coating |
| | | | | proven with |
| | | | | CNTs |
| Li Ion | ~300 | 100-150 | Good | Existing |
| Cathode | | | | technology |
| Li/S | 1673 | ~150 | Poor | Polysulfide |
| Standard | | | | cycle causes |
| Cathode | | | | degradation |
| NiS | 1673 | ~1000 | Moderate | protective |
| Experimental | | | | coatings |
| Cathode | | | | |
| Present | 3800 | 1500 | Good | Si 30-50 nm |
| Invention | | | | coated CNT |
| Anode | | | | |
| Present | 1506 | 1000 | Good | Sulfur (alloy) |
| Invention | | | | |
| Cathode | | | | |

One advantage of CNT sheet electrodes made according to the process of the present invention is their positive coefficient of resistivity with temperature.

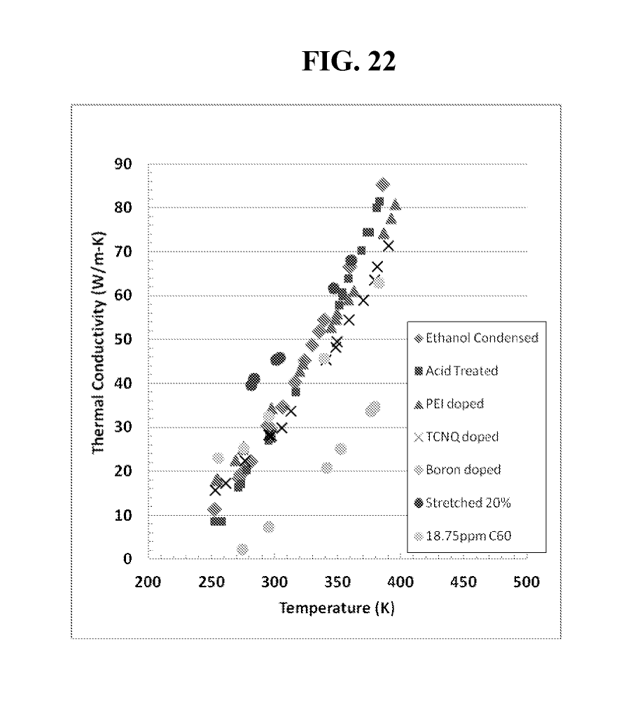

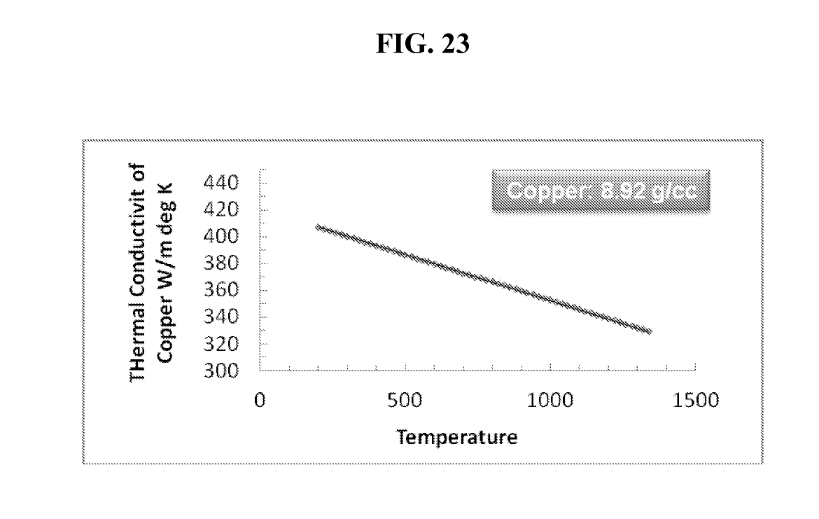

Thermal conductivity versus temperature data for a variety of different CNT sheet treatments is shown in FIG. 22. Thermal conductivity versus temperature for the pure uncoated copper foil is shown in FIG. 23. This property provides the potential for the battery electrode to be self-temperature regulating. As the electrode gets hot, its thermal conductivity increases, so if there is a hot spot the battery material will conduct heat away faster to remove it. This is quite different than the copper/aluminum metal foils currently in use. It may be possible to remove internal sensors, valves and temperature measurement probes thereby reducing cost.

Another advantage of using CNT electrode material of the present invention is the low electrical resistivity of the entire electrode. Present technology uses a paste of active media, binders, and graphite powder for the anode. The resistivity of this paste dominates the resistivity of the system so that CNT electrode are more conductive as shown in Table 5. The Joule heating of these electrodes under high current load, may be significantly less than current technology and the higher thermal conductivity may help carry away any localized heat that is generated.

Table 5 shows the resistivity of a CNT sheet electrode of the present invention compared with a copper paste coated electrode, showing improved resistivity and thermal conductivity.

TABLE 5

| | | Thermal |
|---|---|---|
| | Resistivity | conductivity |
| | 1 × 10⁻³ Ω · cm | W · m⁻¹K⁻¹ |
| Si-coated CNT fabric | 2.93 ± 0.34 | 17.59 ± 2.32 |
| Compressed Si nanopowder | 327,500 ± 22,000 | 0.40 |
| electrode | | |
| Graphite electrode | 5.0 | 1.04 |

The replacement of heavy and fatigue prone systems with CNT electrodes not only permits a much lighter battery. Furthermore the safety advantages of the CNT material permit the elimination of temperature monitoring and regulating systems so that the weight advantage is increased. The flexible nature of the CNT electrodes, enables a new kind of packing that saves space. For example, conformal batteries can be fabricated to better use the available space.

In addition to the applications previously described herein, the batteries can also have applications in aircraft, rockets and drones. These are applications where weight is a premium. Also, applications include automotive use in which existing batteries are very inadequate. For example, the range of the Nissan Leaf is about 73 miles before it has to undergo a 12 hour recharge at 110V. A practical range equivalent to IC powered cars of approximately 400 miles is considered necessary before electric vehicles can enter the main-stream market. This technology should meet this demand with a system that exceeds the present safety needs.

All references cited herein are incorporated by reference herein in their entirety.

While the present invention has been described with reference to certain embodiments thereof, it should be understood by those skilled in the art that various changes may be made and equivalents may be substituted without departing from the true spirit and scope of the invention. In addition, many modifications may be made to adapt to a particular situation, indication, material and composition of matter, process step or steps, without departing from the spirit and scope of the present invention. All such modifications are intended to be within the scope of the claims appended hereto.

What is claimed is:

1. A battery comprising:
a negative electrode including an anode current collector having at least one sheet of carbon nanotubes and semiconductor material deposited on the sheet;
a positive electrode including a cathode current collector having at least one sheet of carbon nanotubes having a nickel sulfide or a tin sulfide deposited on the sheet; and
a separator, situated between the negative electrode and positive electrode.

2. A battery of claim 1, wherein the sheets are made from single wall carbon nanotubes.

3. A battery of claim 1, wherein the sheets are made from multi-wall carbon nanotubes.

4. A battery of claim 1, wherein the semiconductor material includes silicon or germanium.

5. A battery of claim 1, wherein the semiconductor material includes particles that are welded on the carbon nanotubes.

6. A battery of claim 1, further including a casing made from carbon nanotube composite material.

7. A battery of claim 6, wherein the composite material includes polyamide, polyphenylene sulfide, polyether ether ketone, polypropylene, bispolyamide, bismaleimide, epoxies and combination thereof.

8. A battery of claim 1, wherein the separator is a porous polyethylene membrane, or polyethylene membrane, or a combination thereof.

9. A battery of claim 1, wherein the sheets of carbon nanotubes has density of about 80 g/m².

10. A battery of claim 1, wherein the battery is a prismatic battery.

11. A battery of claim 1, wherein the sheet of carbon nanotubes comprises substantially aligned carbon nanotubes.

12. A battery of claim 1, wherein the sheet of carbon nanotubes further comprises lithium as an intercalation compound.

13. A battery of claim 8, wherein the separator is soaked in an electrolyte solution.

14. A method for forming a cathode for use in a battery, the method comprising:
depositing nickel on a carbon nanotube sheet; and
converting the nickel to nickel sulfide.

15. A method of claim 14, wherein the step of depositing nickel on a carbon nanotube sheet includes electrodepositing nickel on the carbon nanotube sheet.

16. A method of claim 14, wherein converting the nickel to nickel sulfide includes a heating process.

17. A method for forming a cathode for use in a battery, the method comprising:
depositing tin on a carbon nanotube sheet; and
converting the tin to tin sulfide.

18. A method of claim 17, wherein the step of depositing tin on the carbon nanotube sheet includes electrodepositing tin on the carbon nanotube sheet.

19. A method of claim 17, wherein converting tin to tin sulfide includes a heating process.

20. A method for forming an anode for use in a battery, the method comprising:
providing a substantially planar body defined by a matrix of carbon nanotubes; and
spraying nickel sulfide or tin sulfide onto the matrix.

21. A method of manufacturing a battery, the method comprising:
incorporating a plurality of semiconductor particles into a first a sheet of carbon nanotubes to form a negative electrode;
depositing nickel sulfide or tin sulfide on a second sheet of carbon nanotubes to from a positive electrode;
positioning between the positive and negative electrodes a separator; and
sealing the positive and negative electrodes and the separator with a casing of the carbon nanotube sheet.

22. A method of claim 21, wherein, in the step of incorporating, the semiconductor particles are welded onto the carbon nanotubes.

23. A method of claim 21, wherein, in the step of incorporating, the semiconductor particles are silicon or germanium particles.

24. A method of claim 21, wherein, in the step of sealing, the casing includes carbon nanotube composite material.

25. A method of claim 24, wherein in the step of sealing, the composite material comprises polyamide, polyphenylene sulfide, polyether ether ketone, polypropylene, bispolyamide, bismaleimide, epoxies and combination thereof.

26. A method of claim 21, wherein in the step of positioning, the separator is a porous polyethylene membrane, or polyethylene membrane, or a combination thereof.

27. A cathode for use in a battery, comprising:
at least one sheet of carbon nanotubes; and
nickel sulfide or tin sulfide deposited on the sheet.
